(19) United States
(12) Patent Application Publication
(10) Pub. No.: US 2025/0133624 A1
(43) Pub. Date: Apr. 24, 2025

(54) MULTICAST SESSION SUSPENSION AND RESUME IN WIRELESS COMMUNICATION SYSTEM

(71) Applicant: LG ELECTRONICS INC., Seoul (KR)

(72) Inventor: Sangwon KIM, Seoul (KR)

(73) Assignee: LG ELECTRONICS INC., Seoul (KR)

(21) Appl. No.: 18/835,185

(22) PCT Filed: Mar. 24, 2023
(86) PCT No.: PCT/KR2023/003971

§ 371 Date: Aug. 1, 2024

Related U.S. Application Data
(60) Provisional application No. 63/323,498, filed on Mar. 24, 2022.

(51) Int. Cl. H04W 76/27; H04W 72/0453; H04W 72/1273

(52) U.S. Cl. CPC H04W 76/27; H04W 72/0453; H04W 72/1273

(57) ABSTRACT

The present disclosure relates to multicast session suspension and resume in wireless communications. According to an embodiment of the present disclosure, a user equipment (UE) may monitor a multicast session in a non-connected state, and suspend the monitoring of the multicast session. The UE may monitor a paging in the non-connected state, and based on receiving a paging message including an ID related to the multicast session and not including an ID of the UE in the non-connected state, the UE may resume the monitoring of the multicast session in the non-connected state without transitioning to a connected state.

### CROSS-REFERENCE TO RELATED APPLICATION(S)

This application is the National Stage filing under 35 U.S.C. 371 of International Application No. PCT/KR2023/003971, filed on Mar. 24, 2023, which claims the benefit of U.S. Provisional Application No. 63/323,498, filed on Mar. 24, 2022, the contents of which are all incorporated by reference herein in their entirety.

### TECHNICAL FIELD

The present disclosure relates to multicast session suspension and resume in wireless communications.

### BACKGROUND

3rd Generation Partnership Project (3GPP) Long-Term Evolution (LTE) is a technology for enabling high-speed packet communications. Many schemes have been proposed for the LTE objective including those that aim to reduce user and provider costs, improve service quality, and expand and improve coverage and system capacity. The 3GPP LTE requires reduced cost per bit, increased service availability, flexible use of a frequency band, a simple structure, an open interface, and adequate power consumption of a terminal as an upper-level requirement.

Work has started in International Telecommunication Union (ITU) and 3GPP to develop requirements and specifications for New Radio (NR) systems. 3GPP has to identify and develop the technology components needed for successfully standardizing the new RAT timely satisfying both the urgent market needs, and the more long-term requirements set forth by the ITU Radio communication sector (ITU-R) International Mobile Telecommunications (IMT)-2020 process. Further, the NR should be able to use any spectrum band ranging at least up to 100 GHz that may be made available for wireless communications even in a more distant future.

The NR targets a single technical framework addressing all usage scenarios, requirements and deployment scenarios including enhanced Mobile BroadBand (eMBB), massive Machine Type Communications (mMTC), Ultra-Reliable and Low Latency Communications (URLLC), etc. The NR shall be inherently forward compatible.

In multicast communication service, the same service and the same specific content data may be provided simultaneously to a dedicated set of UEs (i.e., not all UEs in a multicast coverage area may be authorized to receive the data). The multicast communication service may be delivered to the UEs using a multicast session. The multicast session may be suspended and/or resumed.

### SUMMARY

According to an embodiment of the present disclosure, a method performed by a user equipment (UE) configured to operate in a wireless communication system comprises: monitoring a multicast session in a non-connected state; suspending the monitoring of the multicast session; monitoring a paging in the non-connected state; receiving a paging message related to the paging in the non-connected state; and based on the received paging message including an identity (ID) related to the multicast session and not including an ID of the UE, resuming the monitoring of the multicast session in the non-connected state without transitioning to a connected state.

According to an embodiment of the present disclosure, a user equipment (UE) configured to operate in a wireless communication system comprises: at least one transceiver; at least one processor; and at least one memory operatively coupled to the at least one processor and storing instructions that, based on being executed by the at least one processor, perform operations comprising: monitoring a multicast session in a non-connected state; suspending the monitoring of the multicast session; monitoring a paging in the non-connected state; receiving a paging message related to the paging in the non-connected state; and based on the received paging message including an identity (ID) related to the multicast session and not including an ID of the UE, resuming the monitoring of the multicast session in the non-connected state without transitioning to a connected state.

According to an embodiment of the present disclosure, a network node configured to operate in a wireless communication system comprises: at least one transceiver; at least one processor; and at least one memory operatively coupled to the at least one processor and storing instructions that, based on being executed by the at least one processor, perform operations comprising: providing a multicast session to a user equipment (UE) in a non-connected state; suspending the multicast session provided to the UE; transmitting, to the UE the non-connected state, a suspend notification for the multicast session based on suspending the multicast session; resuming the suspended multicast session; transmitting, to the UE in the non-connected state, a paging message including an identity (ID) related to the multicast session and not including an ID of the UE based on resuming the suspended multicast session; and providing the multicast session to the UE in the non-connected state after transmitting the paging message, wherein the UE suspends monitoring of the multicast session based on receiving the suspend notification for the multicast session from the network node, and wherein the UE resumes the monitoring of the multicast session in the non-connected state without transitioning to a connected state based on the paging message including the ID related to the multicast session and not including an ID of the UE.

According to an embodiment of the present disclosure, a method performed by a network node configured to operate in a wireless communication system comprises: providing a multicast session to a user equipment (UE) in a non-connected state; suspending the multicast session provided to the UE; transmitting, to the UE the non-connected state, a suspend notification for the multicast session based on suspending the multicast session; resuming the suspended multicast session; transmitting, to the UE in the non-connected state, a paging message including an identity (ID) related to the multicast session based on resuming the suspended multicast session; and providing the multicast session to the UE in the non-connected state after transmitting the paging message, wherein the UE suspends monitoring of the multicast session based on receiving the suspend notification for the multicast session from the network node, and wherein the UE resumes the monitoring of the multicast session in the non-connected state without transitioning to a connected state based on the paging message including the ID related to the multicast session and not including an ID of the UE.

According to an embodiment of the present disclosure, an apparatus adapted to operate in a wireless communication system comprises: at least processor; and at least one memory operatively coupled to the at least one processor and storing instructions that, based on being executed by the at least one processor, perform operations comprising: monitoring a multicast session in a non-connected state; suspending the monitoring of the multicast session; monitoring a paging in the non-connected state; receiving a paging message related to the paging in the non-connected state; and based on the received paging message including an identity (ID) related to the multicast session and not including an ID of the UE, resuming the monitoring of the multicast session in the non-connected state without transitioning to a connected state.

According to an embodiment of the present disclosure, a non-transitory computer readable medium (CRM) has stored thereon a program code implementing instructions that, based on being executed by at least one processor, perform operations comprising: monitoring a multicast session in a non-connected state; suspending the monitoring of the multicast session; monitoring a paging in the non-connected state; receiving a paging message related to the paging in the non-connected state; and based on the received paging message including an identity (ID) related to the multicast session and not including an ID of the UE, resuming the monitoring of the multicast session in the non-connected state without transitioning to a connected state.

### BRIEF DESCRIPTION OF THE DRAWINGS

FIG. 1 shows an example of a communication system to which implementations of the present disclosure is applied.

FIG. 2 shows an example of wireless devices to which implementations of the present disclosure is applied.

FIG. 3 shows an example of UE to which implementations of the present disclosure is applied.

FIGS. 4 and 5 show an example of protocol stacks in a 3GPP based wireless communication system to which implementations of the present disclosure is applied.

FIG. 6 shows a frame structure in a 3GPP based wireless communication system to which implementations of the present disclosure is applied.

FIG. 7 shows a data flow example in the 3GPP NR system to which implementations of the present disclosure is applied.

FIG. 8 shows an example of possible RRC states in a wireless communication system to which technical features of the present disclosure can be applied.

FIG. 9 shows an example of bandwidth adaptation according to an embodiment of the present disclosure.

FIG. 10 shows an example of a BWP configuration to which technical features of the present disclosure is applied.

FIG. 11 shows an example of a method performed by a UE according to an embodiment of the present disclosure.

FIG. 12 shows an example of a method performed by a network node according to an embodiment of the present disclosure.

FIG. 13 shows an example of a signal flow for suspending/resuming monitoring of multicast session according to an embodiment of the present disclosure.

### DETAILED DESCRIPTION

The following techniques, apparatuses, and systems may be applied to a variety of wireless multiple access systems. Examples of the multiple access systems include a Code Division Multiple Access (CDMA) system, a Frequency Division Multiple Access (FDMA) system, a Time Division Multiple Access (TDMA) system, an Orthogonal Frequency Division Multiple Access (OFDMA) system, a Single Carrier Frequency Division Multiple Access (SC-FDMA) system, and a Multi Carrier Frequency Division Multiple Access (MC-FDMA) system. CDMA may be embodied through radio technology such as Universal Terrestrial Radio Access (UTRA) or CDMA2000. TDMA may be embodied through radio technology such as Global System for Mobile communications (GSM), General Packet Radio Service (GPRS), or Enhanced Data rates for GSM Evolution (EDGE). OFDMA may be embodied through radio technology such as Institute of Electrical and Electronics Engineers (IEEE) 802.11 (Wi-Fi), IEEE 802.16 (WiMAX), IEEE 802.20, or Evolved UTRA (E-UTRA). UTRA is a part of a Universal Mobile Telecommunications System (UMTS). 3rd Generation Partnership Project (3GPP) Long-Term Evolution (LTE) is a part of Evolved UMTS (E-UMTS) using E-UTRA. 3GPP LTE employs OFDMA in downlink (DL) and SC-FDMA in uplink (UL). Evolution of 3GPP LTE includes LTE-Advanced (LTE-A), LTE-A Pro, and/or 5G New Radio (NR).

For convenience of description, implementations of the present disclosure are mainly described in regards to a 3GPP based wireless communication system. However, the technical features of the present disclosure are not limited thereto. For example, although the following detailed description is given based on a mobile communication system corresponding to a 3GPP based wireless communication system, aspects of the present disclosure that are not limited to 3GPP based wireless communication system are applicable to other mobile communication systems.

For terms and technologies which are not specifically described among the terms of and technologies employed in the present disclosure, the wireless communication standard documents published before the present disclosure may be referenced.

In the present disclosure, “A or B” may mean “only A”, “only B”, or “both A and B”. In other words, “A or B” in the present disclosure may be interpreted as “A and/or B”. For example, “A, B or C” in the present disclosure may mean “only A”, “only B”, “only C”, or “any combination of A, B and C”.

In the present disclosure, slash (/) or comma (,) may mean “and/or”. For example, “A/B” may mean “A and/or B”. Accordingly, “A/B” may mean “only A”, “only B”, or “both A and B”. For example, “A, B, C” may mean “A, B or C”.

In the present disclosure, “at least one of A and B” may mean “only A”, “only B” or “both A and B”. In addition, the expression “at least one of A or B” or “at least one of A and/or B” in the present disclosure may be interpreted as same as “at least one of A and B”.

In addition, in the present disclosure, “at least one of A, B and C” may mean “only A”, “only B”, “only C”, or “any combination of A, B and C”. In addition, “at least one of A, B or C” or “at least one of A, B and/or C” may mean “at least one of A, B and C”.

Also, parentheses used in the present disclosure may mean “for example”. In detail, when it is shown as “control information (PDCCH)”, “PDCCH” may be proposed as an example of “control information”. In other words, “control information” in the present disclosure is not limited to “PDCCH”, and “PDCCH” may be proposed as an example of “control information”. In addition, even when shown as “control information (i.e., PDCCH)”, “PDCCH” may be proposed as an example of “control information”.

Technical features that are separately described in one drawing in the present disclosure may be implemented separately or simultaneously.

Although not limited thereto, various descriptions, functions, procedures, suggestions, methods and/or operational flowcharts of the present disclosure disclosed herein can be applied to various fields requiring wireless communication and/or connection (e.g., 5G) between devices.

Hereinafter, the present disclosure will be described in more detail with reference to drawings. The same reference numerals in the following drawings and/or descriptions may refer to the same and/or corresponding hardware blocks, software blocks, and/or functional blocks unless otherwise indicated.

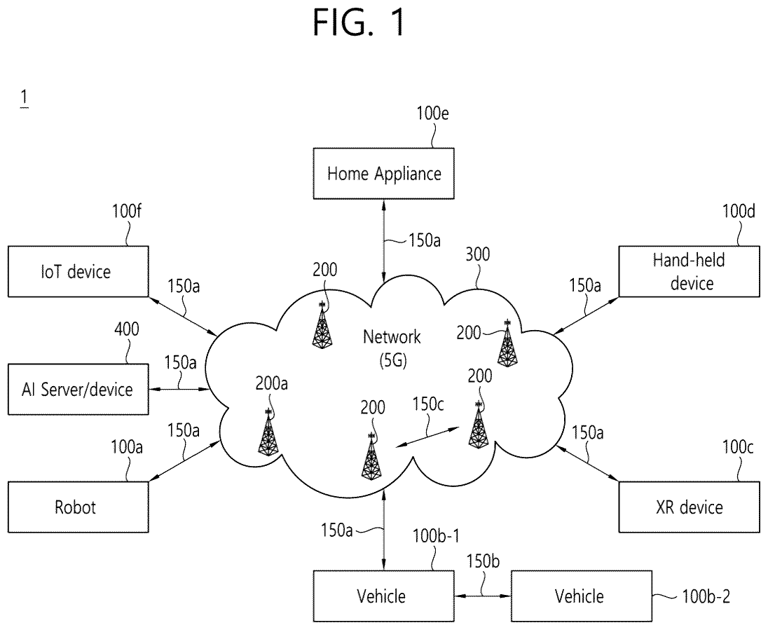

FIG. 1 shows an example of a communication system to which implementations of the present disclosure is applied.

The 5G usage scenarios shown in FIG. 1 are only exemplary, and the technical features of the present disclosure can be applied to other 5G usage scenarios which are not shown in FIG. 1.

Three main requirement categories for 5G include (1) a category of enhanced Mobile BroadBand (eMBB), (2) a category of massive Machine Type Communication (mMTC), and (3) a category of Ultra-Reliable and Low Latency Communications (URLLC).

Referring to FIG. 1, the communication system 1 includes wireless devices 100a to 100f, Base Stations (BSs) 200, and a network 300. Although FIG. 1 illustrates a 5G network as an example of the network of the communication system 1, the implementations of the present disclosure are not limited to the 5G system, and can be applied to the future communication system beyond the 5G system.

The BSs 200 and the network 300 may be implemented as wireless devices and a specific wireless device may operate as a BS/network node with respect to other wireless devices.

The wireless devices 100a to 100f represent devices performing communication using Radio Access Technology (RAT) (e.g., 5G NR or LTE) and may be referred to as communication/radio/5G devices. The wireless devices 100a to 100f may include, without being limited to, a robot 100a, vehicles 100b-1 and 100b-2, an eXtended Reality (XR) device 100c, a hand-held device 100d, a home appliance 100e, an Internet-of-Things (IoT) device 100f, and an Artificial Intelligence (AI) device/server 400. For example, the vehicles may include a vehicle having a wireless communication function, an autonomous driving vehicle, and a vehicle capable of performing communication between vehicles. The vehicles may include an Unmanned Aerial Vehicle (UAV) (e.g., a drone). The XR device may include an Augmented Reality (AR)/Virtual Reality (VR)/Mixed Reality (MR) device and may be implemented in the form of a Head-Mounted Device (HMD), a Head-Up Display (HUD) mounted in a vehicle, a television, a smartphone, a computer, a wearable device, a home appliance device, a digital signage, a vehicle, a robot, etc. The hand-held device may include a smartphone, a smartpad, a wearable device (e.g., a smartwatch or a smartglasses), and a computer (e.g., a notebook). The home appliance may include a TV, a refrigerator, and a washing machine. The IoT device may include a sensor and a smartmeter.

In the present disclosure, the wireless devices 100a to 100f may be called User Equipments (UEs). A UE may include, for example, a cellular phone, a smartphone, a laptop computer, a digital broadcast terminal, a Personal Digital Assistant (PDA), a Portable Multimedia Player (PMP), a navigation system, a slate Personal Computer (PC), a tablet PC, an ultrabook, a vehicle, a vehicle having an autonomous traveling function, a connected car, an UAV, an AI module, a robot, an AR device, a VR device, an MR device, a hologram device, a public safety device, an MTC device, an IoT device, a medical device, a FinTech device (or a financial device), a security device, a weather/environment device, a device related to a 5G service, or a device related to a fourth industrial revolution field.

The wireless devices 100a to 100f may be connected to the network 300 via the BSs 200. An AI technology may be applied to the wireless devices 100a to 100f and the wireless devices 100a to 100f may be connected to the AI server 400 via the network 300. The network 300 may be configured using a 3G network, a 4G (e.g., LTE) network, a 5G (e.g., NR) network, and a beyond-5G network. Although the wireless devices 100a to 100f may communicate with each other through the BSs 200/network 300, the wireless devices 100a to 100f may perform direct communication (e.g., sidelink communication) with each other without passing through the BSs 200/network 300. For example, the vehicles 100b-1 and 100b-2 may perform direct communication (e.g., Vehicle-to-Vehicle (V2V)/Vehicle-to-everything (V2X) communication). The IoT device (e.g., a sensor) may perform direct communication with other IoT devices (e.g., sensors) or other wireless devices 100a to 100f.

Wireless communication/connections 150a, 150b and 150c may be established between the wireless devices 100a to 100f and/or between wireless device 100a to 100f and BS 200 and/or between BSs 200. Herein, the wireless communication/connections may be established through various RATs (e.g., 5GNR) such as uplink/downlink communication 150a, sidelink communication (or Device-to-Device (D2D) communication) 150b, inter-base station communication 150c (e.g., relay, Integrated Access and Backhaul (IAB)), etc. The wireless devices 100a to 100f and the BSs 200/the wireless devices 100a to 100f may transmit/receive radio signals to/from each other through the wireless communication/connections 150a, 150b and 150c. For example, the wireless communication/connections 150a, 150b and 150c may transmit/receive signals through various physical channels. To this end, at least a part of various configuration information configuring processes, various signal processing processes (e.g., channel encoding/decoding, modulation/demodulation, and resource mapping/de-mapping), and resource allocating processes, for transmitting/receiving radio signals, may be performed based on the various proposals of the present disclosure.

NR supports multiples numerologies (and/or multiple Sub-Carrier Spacings (SCS)) to support various 5G services. For example, if SCS is 15 kHz, wide area can be supported in traditional cellular bands, and if SCS is 30 kHz/60 kHz, dense-urban, lower latency, and wider carrier bandwidth can be supported. If SCS is 60 kHz or higher, bandwidths greater than 24.25 GHz can be supported to overcome phase noise.

The NR frequency band may be defined as two types of frequency range, i.e., Frequency Range 1 (FR1) and Frequency Range 2 (FR2). The numerical value of the frequency range may be changed. For example, the frequency ranges of the two types (FR1 and FR2) may be as shown in Table 1 below. For ease of explanation, in the frequency ranges used in the NR system, FR1 may mean “sub 6 GHz range”, FR2 may mean “above 6 GHz range,” and may be referred to as millimeter Wave (mmW).

TABLE 1

| Frequency | | |
|---|---|---|
| Range | Corresponding | |
| designation | frequency range | Subcarrier Spacing |
| FR1 | 450 MHz-6000 MHz | 15, 30, 60 kHz |
| FR2 | 24250 MHz-52600 MHz | 60, 120, 240 kHz |

As mentioned above, the numerical value of the frequency range of the NR system may be changed. For example, FR1 may include a frequency band of 410 MHz to 7125 MHz as shown in Table 2 below. That is, FR1 may include a frequency band of 6 GHz (or 5850, 5900, 5925 MHz, etc.) or more. For example, a frequency band of 6 GHz (or 5850, 5900, 5925 MHz, etc.) or more included in FR1 may include an unlicensed band. Unlicensed bands may be used for a variety of purposes, for example for communication for vehicles (e.g., autonomous driving).

TABLE 2

| Frequency | | |
|---|---|---|
| Range | Corresponding | |
| designation | frequency range | Subcarrier Spacing |
| FR1 | 410 MHz-7125 MHz | 15, 30, 60 kHz |
| FR2 | 24250 MHz-52600 MHz | 60, 120, 240 kHz |

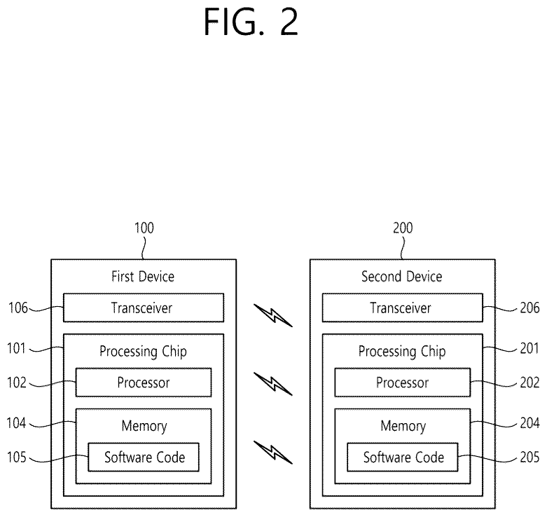

Here, the radio communication technologies implemented in the wireless devices in the present disclosure may include NarrowBand IoT (NB-IoT) technology for low-power communication as well as LTE, NR and 6G. For example, NB-IoT technology may be an example of Low Power Wide Area Network (LPWAN) technology, may be implemented in specifications such as LTE Cat NB1 and/or LTE Cat NB2, and may not be limited to the above-mentioned names. Additionally and/or alternatively, the radio communication technologies implemented in the wireless devices in the present disclosure may communicate based on LTE-M technology. For example, LTE-M technology may be an example of LPWAN technology and be called by various names such as enhanced MTC (eMTC). For example, LTE-M technology may be implemented in at least one of the various specifications, such as 1) LTE Cat 0, 2) LTE Cat M1, 3) LTE Cat M2, 4) LTE non-bandwidth limited (non-BL), 5) LTE-MTC, 6) LTE Machine Type Communication, and/or 7) LTE M, and may not be limited to the above-mentioned names. Additionally and/or alternatively, the radio communication technologies implemented in the wireless devices in the present disclosure may include at least one of ZigBee, Bluetooth, and/or LPWAN which take into account low-power communication, and may not be limited to the above-mentioned names. For example, ZigBee technology may generate Personal Area Networks (PANs) associated with small/low-power digital communication based on various specifications such as IEEE 802.15.4 and may be called various names. FIG. 2 shows an example of wireless devices to which implementations of the present disclosure is applied.

In FIG. 2, The first wireless device 100 and/or the second wireless device 200 may be implemented in various forms according to use cases/services. For example, {the first wireless device 100 and the second wireless device 200} may correspond to at least one of {the wireless device 100a to 100f and the BS 200}, {the wireless device 100a to 100f and the wireless device 100a to 100f} and/or {the BS 200 and the BS 200} of FIG. 1. The first wireless device 100 and/or the second wireless device 200 may be configured by various elements, devices/parts, and/or modules.

The first wireless device 100 may include at least one transceiver, such as a transceiver 106, at least one processing chip, such as a processing chip 101, and/or one or more antennas 108.

The processing chip 101 may include at least one processor, such a processor 102, and at least one memory, such as a memory 104. Additional and/or alternatively, the memory 104 may be placed outside of the processing chip 101.

The processor 102 may control the memory 104 and/or the transceiver 106 and may be adapted to implement the descriptions, functions, procedures, suggestions, methods and/or operational flowcharts described in the present disclosure. For example, the processor 102 may process information within the memory 104 to generate first information/signals and then transmit radio signals including the first information/signals through the transceiver 106. The processor 102 may receive radio signals including second information/signals through the transceiver 106 and then store information obtained by processing the second information/signals in the memory 104.

The memory 104 may be operably connectable to the processor 102. The memory 104 may store various types of information and/or instructions. The memory 104 may store a firmware and/or a software code 105 which implements codes, commands, and/or a set of commands that, when executed by the processor 102, perform the descriptions, functions, procedures, suggestions, methods and/or operational flowcharts disclosed in the present disclosure. For example, the firmware and/or the software code 105 may implement instructions that, when executed by the processor 102, perform the descriptions, functions, procedures, suggestions, methods and/or operational flowcharts disclosed in the present disclosure. For example, the firmware and/or the software code 105 may control the processor 102 to perform one or more protocols. For example, the firmware and/or the software code 105 may control the processor 102 to perform one or more layers of the radio interface protocol.

Herein, the processor 102 and the memory 104 may be a part of a communication modem/circuit/chip designed to implement RAT (e.g., LTE or NR). The transceiver 106 may be connected to the processor 102 and transmit and/or receive radio signals through one or more antennas 108. Each of the transceiver 106 may include a transmitter and/or a receiver. The transceiver 106 may be interchangeably used with Radio Frequency (RF) unit(s). In the present disclosure, the first wireless device 100 may represent a communication modem/circuit/chip.

The second wireless device 200 may include at least one transceiver, such as a transceiver 206, at least one processing chip, such as a processing chip 201, and/or one or more antennas 208.

The processing chip 201 may include at least one processor, such a processor 202, and at least one memory, such as a memory 204. Additional and/or alternatively, the memory 204 may be placed outside of the processing chip 201.

The processor 202 may control the memory 204 and/or the transceiver 206 and may be adapted to implement the descriptions, functions, procedures, suggestions, methods and/or operational flowcharts described in the present disclosure. For example, the processor 202 may process information within the memory 204 to generate third information/signals and then transmit radio signals including the third information/signals through the transceiver 206. The processor 202 may receive radio signals including fourth information/signals through the transceiver 106 and then store information obtained by processing the fourth information/signals in the memory 204.

The memory 204 may be operably connectable to the processor 202. The memory 204 may store various types of information and/or instructions. The memory 204 may store a firmware and/or a software code 205 which implements codes, commands, and/or a set of commands that, when executed by the processor 202, perform the descriptions, functions, procedures, suggestions, methods and/or operational flowcharts disclosed in the present disclosure. For example, the firmware and/or the software code 205 may implement instructions that, when executed by the processor 202, perform the descriptions, functions, procedures, suggestions, methods and/or operational flowcharts disclosed in the present disclosure. For example, the firmware and/or the software code 205 may control the processor 202 to perform one or more protocols. For example, the firmware and/or the software code 205 may control the processor 202 to perform one or more layers of the radio interface protocol.

Herein, the processor 202 and the memory 204 may be a part of a communication modem/circuit/chip designed to implement RAT (e.g., LTE or NR). The transceiver 206 may be connected to the processor 202 and transmit and/or receive radio signals through one or more antennas 208. Each of the transceiver 206 may include a transmitter and/or a receiver. The transceiver 206 may be interchangeably used with RF unit. In the present disclosure, the second wireless device 200 may represent a communication modem/circuit/chip.

Hereinafter, hardware elements of the wireless devices 100 and 200 will be described more specifically. One or more protocol layers may be implemented by, without being limited to, one or more processors 102 and 202. For example, the one or more processors 102 and 202 may implement one or more layers (e.g., functional layers such as Physical (PHY) layer, Media Access Control (MAC) layer, Radio Link Control (RLC) layer, Packet Data Convergence Protocol (PDCP) layer, Radio Resource Control (RRC) layer, and Service Data Adaptation Protocol (SDAP) layer). The one or more processors 102 and 202 may generate one or more Protocol Data Units (PDUs), one or more Service Data Unit (SDUs), messages, control information, data, or information according to the descriptions, functions, procedures, suggestions, methods and/or operational flowcharts disclosed in the present disclosure. The one or more processors 102 and 202 may generate signals (e.g., baseband signals) including PDUs, SDUs, messages, control information, data, or information according to the descriptions, functions, procedures, suggestions, methods and/or operational flowcharts disclosed in the present disclosure and provide the generated signals to the one or more transceivers 106 and 206. The one or more processors 102 and 202 may receive the signals (e.g., baseband signals) from the one or more transceivers 106 and 206 and acquire the PDUs, SDUs, messages, control information, data, or information according to the descriptions, functions, procedures, suggestions, methods and/or operational flowcharts disclosed in the present disclosure.

The one or more processors 102 and 202 may be referred to as controllers, microcontrollers, microprocessors, or microcomputers. The one or more processors 102 and 202 may be implemented by hardware, firmware, software, or a combination thereof. As an example, one or more Application Specific Integrated Circuits (ASICs), one or more Digital Signal Processors (DSPs), one or more Digital Signal Processing Devices (DSPDs), one or more Programmable Logic Devices (PLDs), or one or more Field Programmable Gate Arrays (FPGAs) may be included in the one or more processors 102 and 202. For example, the one or more processors 102 and 202 may be configured by a set of a communication control processor, an Application Processor (AP), an Electronic Control Unit (ECU), a Central Processing Unit (CPU), a Graphic Processing Unit (GPU), and a memory control processor.

The one or more memories 104 and 204 may be connected to the one or more processors 102 and 202 and store various types of data, signals, messages, information, programs, code, instructions, and/or commands. The one or more memories 104 and 204 may be configured by Random Access Memory (RAM), Dynamic RAM (DRAM), Read-Only Memory (ROM), electrically Erasable Programmable Read-Only Memory (EPROM), flash memory, volatile memory, non-volatile memory, hard drive, register, cash memory, computer-readable storage medium, and/or combinations thereof. The one or more memories 104 and 204 may be located at the interior and/or exterior of the one or more processors 102 and 202. The one or more memories 104 and 204 may be connected to the one or more processors 102 and 202 through various technologies such as wired or wireless connection.

The one or more transceivers 106 and 206 may transmit user data, control information, and/or radio signals/channels, mentioned in the descriptions, functions, procedures, suggestions, methods and/or operational flowcharts disclosed in the present disclosure, to one or more other devices. The one or more transceivers 106 and 206 may receive user data, control information, and/or radio signals/channels, mentioned in the descriptions, functions, procedures, suggestions, methods and/or operational flowcharts disclosed in the present disclosure, from one or more other devices. For example, the one or more transceivers 106 and 206 may be connected to the one or more processors 102 and 202 and transmit and receive radio signals. For example, the one or more processors 102 and 202 may perform control so that the one or more transceivers 106 and 206 may transmit user data, control information, or radio signals to one or more other devices. The one or more processors 102 and 202 may perform control so that the one or more transceivers 106 and 206 may receive user data, control information, or radio signals from one or more other devices.

The one or more transceivers 106 and 206 may be connected to the one or more antennas 108 and 208. Additionally and/or alternatively, the one or more transceivers 106 and 206 may include one or more antennas 108 and 208. The one or more transceivers 106 and 206 may be adapted to transmit and receive user data, control information, and/or radio signals/channels, mentioned in the descriptions, functions, procedures, suggestions, methods and/or operational flowcharts disclosed in the present disclosure, through the one or more antennas 108 and 208. In the present disclosure, the one or more antennas 108 and 208 may be a plurality of physical antennas or a plurality of logical antennas (e.g., antenna ports).

The one or more transceivers 106 and 206 may convert received user data, control information, radio signals/channels, etc., from RF band signals into baseband signals in order to process received user data, control information, radio signals/channels, etc., using the one or more processors 102 and 202. The one or more transceivers 106 and 206 may convert the user data, control information, radio signals/channels, etc., processed using the one or more processors 102 and 202 from the base band signals into the RF band signals. To this end, the one or more transceivers 106 and 206 may include (analog) oscillators and/or filters. For example, the one or more transceivers 106 and 206 can up-convert OFDM baseband signals to OFDM signals by their (analog) oscillators and/or filters under the control of the one or more processors 102 and 202 and transmit the up-converted OFDM signals at the carrier frequency. The one or more transceivers 106 and 206 may receive OFDM signals at a carrier frequency and down-convert the OFDM signals into OFDM baseband signals by their (analog) oscillators and/or filters under the control of the one or more processors 102 and 202.

Although not shown in FIG. 2, the wireless devices 100 and 200 may further include additional components. The additional components 140 may be variously configured according to types of the wireless devices 100 and 200. For example, the additional components 140 may include at least one of a power unit/battery, an Input/Output (I/O) device (e.g., audio I/O port, video I/O port), a driving device, and a computing device. The additional components 140 may be coupled to the one or more processors 102 and 202 via various technologies, such as a wired or wireless connection.

In the implementations of the present disclosure, a UE may operate as a transmitting device in Uplink (UL) and as a receiving device in Downlink (DL). In the implementations of the present disclosure, a BS may operate as a receiving device in UL and as a transmitting device in DL. Hereinafter, for convenience of description, it is mainly assumed that the first wireless device 100 acts as the UE, and the second wireless device 200 acts as the BS. For example, the processor(s) 102 connected to, mounted on or launched in the first wireless device 100 may be adapted to perform the UE behavior according to an implementation of the present disclosure or control the transceiver(s) 106 to perform the UE behavior according to an implementation of the present disclosure. The processor(s) 202 connected to, mounted on or launched in the second wireless device 200 may be adapted to perform the BS behavior according to an implementation of the present disclosure or control the transceiver(s) 206 to perform the BS behavior according to an implementation of the present disclosure.

In the present disclosure, a BS is also referred to as a node B (NB), an eNode B (eNB), or a gNB.

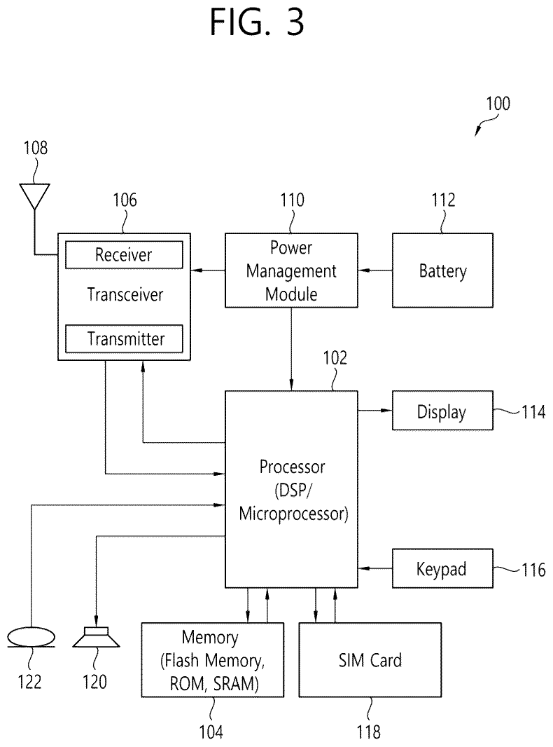

FIG. 3 shows an example of UE to which implementations of the present disclosure is applied.

Referring to FIG. 3, a UE 100 may correspond to the first wireless device 100 of FIG. 2.

A UE 100 includes a processor 102, a memory 104, a transceiver 106, one or more antennas 108, a power management module 141, a battery 142, a display 143, a keypad 144, a Subscriber Identification Module (SIM) card 145, a speaker 146, and a microphone 147.

The processor 102 may be adapted to implement the descriptions, functions, procedures, suggestions, methods and/or operational flowcharts disclosed in the present disclosure. The processor 102 may be adapted to control one or more other components of the UE 100 to implement the descriptions, functions, procedures, suggestions, methods and/or operational flowcharts disclosed in the present disclosure. Layers of the radio interface protocol may be implemented in the processor 102. The processor 102 may include ASIC, other chipset, logic circuit and/or data processing device. The processor 102 may be an application processor. The processor 102 may include at least one of DSP, CPU, GPU, a modem (modulator and demodulator). An example of the processor 102 may be found in SNAPDRAGON™ series of processors made by Qualcomm®, EXYNOS™ series of processors made by Samsung®, A series of processors made by Apple®, HELIO™ series of processors made by MediaTek®, ATOM™ series of processors made by Intel® or a corresponding next generation processor.

The memory 104 is operatively coupled with the processor 102 and stores a variety of information to operate the processor 102. The memory 104 may include ROM, RAM, flash memory, memory card, storage medium and/or other storage device. When the embodiments are implemented in software, the techniques described herein can be implemented with modules (e.g., procedures, functions, etc.) that perform the descriptions, functions, procedures, suggestions, methods and/or operational flowcharts disclosed in the present disclosure. The modules can be stored in the memory 104 and executed by the processor 102. The memory 104 can be implemented within the processor 102 or external to the processor 102 in which case those can be communicatively coupled to the processor 102 via various means as is known in the art.

The transceiver 106 is operatively coupled with the processor 102, and transmits and/or receives a radio signal. The transceiver 106 includes a transmitter and a receiver. The transceiver 106 may include baseband circuitry to process radio frequency signals. The transceiver 106 controls the one or more antennas 108 to transmit and/or receive a radio signal.

The power management module 141 manages power for the processor 102 and/or the transceiver 106. The battery 142 supplies power to the power management module 141.

The display 143 outputs results processed by the processor 102. The keypad 144 receives inputs to be used by the processor 102. The keypad 144 may be shown on the display 143.

The SIM card 145 is an integrated circuit that is intended to securely store the International Mobile Subscriber Identity (IMSI) number and its related key, which are used to identify and authenticate subscribers on mobile telephony devices (such as mobile phones and computers). It is also possible to store contact information on many SIM cards.

The speaker 146 outputs sound-related results processed by the processor 102. The microphone 147 receives sound-related inputs to be used by the processor 102.

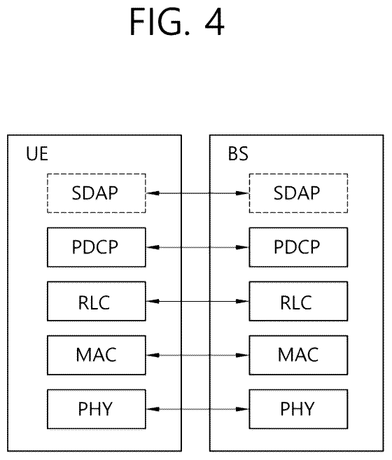

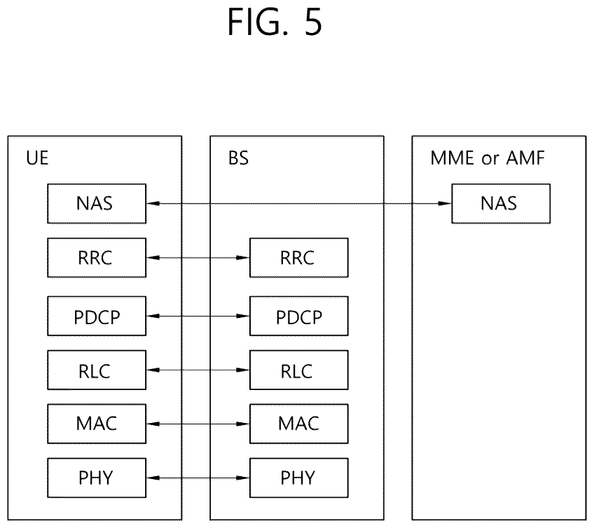

FIGS. 4 and 5 show an example of protocol stacks in a 3GPP based wireless communication system to which implementations of the present disclosure is applied.

In particular, FIG. 4 illustrates an example of a radio interface user plane protocol stack between a UE and a BS and FIG. 5 illustrates an example of a radio interface control plane protocol stack between a UE and a BS. The control plane refers to a path through which control messages used to manage call by a UE and a network are transported. The user plane refers to a path through which data generated in an application layer, for example, voice data or Internet packet data are transported. Referring to FIG. 4, the user plane protocol stack may be divided into Layer 1 (i.e., a PHY layer) and Layer 2. Referring to FIG. 5, the control plane protocol stack may be divided into Layer 1 (i.e., a PHY layer), Layer 2, Layer 3 (e.g., an RRC layer), and a non-access stratum (NAS) layer. Layer 1, Layer 2 and Layer 3 are referred to as an access stratum (AS).

In the 3GPP LTE system, the Layer 2 is split into the following sublayers: MAC, RLC, and PDCP. In the 3GPP NR system, the Layer 2 is split into the following sublayers: MAC, RLC, PDCP and SDAP. The PHY layer offers to the MAC sublayer transport channels, the MAC sublayer offers to the RLC sublayer logical channels, the RLC sublayer offers to the PDCP sublayer RLC channels, the PDCP sublayer offers to the SDAP sublayer radio bearers. The SDAP sublayer offers to 5G core network quality of service (QoS) flows.

In the 3GPP NR system, the main services and functions of the MAC sublayer include: mapping between logical channels and transport channels; multiplexing/de-multiplexing of MAC SDUs belonging to one or different logical channels into/from transport blocks (TB) delivered to/from the physical layer on transport channels; scheduling information reporting; error correction through hybrid automatic repeat request (HARQ) (one HARQ entity per cell in case of carrier aggregation (CA)); priority handling between UEs by means of dynamic scheduling; priority handling between logical channels of one UE by means of logical channel prioritization; padding. A single MAC entity may support multiple numerologies, transmission timings and cells. Mapping restrictions in logical channel prioritization control which numerology(ies), cell(s), and transmission timing(s) a logical channel can use.

Different kinds of data transfer services are offered by MAC. To accommodate different kinds of data transfer services, multiple types of logical channels are defined, i.e., each supporting transfer of a particular type of information. Each logical channel type is defined by what type of information is transferred. Logical channels are classified into two groups: control channels and traffic channels. Control channels are used for the transfer of control plane information only, and traffic channels are used for the transfer of user plane information only. Broadcast control channel (BCCH) is a downlink logical channel for broadcasting system control information, paging control channel (PCCH) is a downlink logical channel that transfers paging information, system information change notifications and indications of ongoing public warning service (PWS) broadcasts, common control channel (CCCH) is a logical channel for transmitting control information between UEs and network and used for UEs having no RRC connection with the network, and dedicated control channel (DCCH) is a point-to-point bi-directional logical channel that transmits dedicated control information between a UE and the network and used by UEs having an RRC connection. Dedicated traffic channel (DTCH) is a point-to-point logical channel, dedicated to one UE, for the transfer of user information. A DTCH can exist in both uplink and downlink. In downlink, the following connections between logical channels and transport channels exist: BCCH can be mapped to broadcast channel (BCH); BCCH can be mapped to downlink shared channel (DL-SCH); PCCH can be mapped to paging channel (PCH); CCCH can be mapped to DL-SCH; DCCH can be mapped to DL-SCH; and DTCH can be mapped to DL-SCH. In uplink, the following connections between logical channels and transport channels exist: CCCH can be mapped to uplink shared channel (UL-SCH); DCCH can be mapped to UL-SCH; and DTCH can be mapped to UL-SCH.

The RLC sublayer supports three transmission modes: transparent mode (TM), unacknowledged mode (UM), and acknowledged node (AM). The RLC configuration is per logical channel with no dependency on numerologies and/or transmission durations. In the 3GPP NR system, the main services and functions of the RLC sublayer depend on the transmission mode and include: transfer of upper layer PDUs; sequence numbering independent of the one in PDCP (UM and AM); error correction through ARQ (AM only); segmentation (AM and UM) and re-segmentation (AM only) of RLC SDUs; reassembly of SDU (AM and UM); duplicate detection (AM only); RLC SDU discard (AM and UM); RLC re-establishment; protocol error detection (AM only).

In the 3GPP NR system, the main services and functions of the PDCP sublayer for the user plane include: sequence numbering; header compression and decompression using robust header compression (ROHC); transfer of user data; reordering and duplicate detection; in-order delivery; PDCP PDU routing (in case of split bearers); retransmission of PDCP SDUs; ciphering, deciphering and integrity protection; PDCP SDU discard; PDCP re-establishment and data recovery for RLC AM; PDCP status reporting for RLC AM; duplication of PDCP PDUs and duplicate discard indication to lower layers. The main services and functions of the PDCP sublayer for the control plane include: sequence numbering; ciphering, deciphering and integrity protection; transfer of control plane data; reordering and duplicate detection; in-order delivery; duplication of PDCP PDUs and duplicate discard indication to lower layers.

In the 3GPP NR system, the main services and functions of SDAP include: mapping between a QoS flow and a data radio bearer; marking QoS flow ID (QFI) in both DL and UL packets. A single protocol entity of SDAP is configured for each individual PDU session.

In the 3GPP NR system, the main services and functions of the RRC sublayer include: broadcast of system information related to AS and NAS; paging initiated by 5GC or NG-RAN; establishment, maintenance and release of an RRC connection between the UE and NG-RAN; security functions including key management; establishment, configuration, maintenance and release of signaling radio bearers (SRBs) and data radio bearers (DRBs); mobility functions (including: handover and context transfer, UE cell selection and reselection and control of cell selection and reselection, inter-RAT mobility); QoS management functions; UE measurement reporting and control of the reporting; detection of and recovery from radio link failure; NAS message transfer to/from NAS from/to UE.

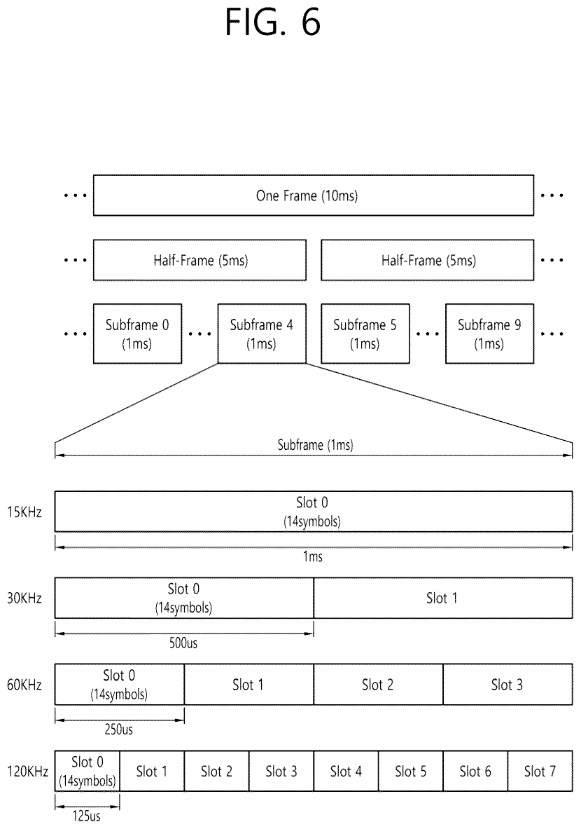

FIG. 6 shows a frame structure in a 3GPP based wireless communication system to which implementations of the present disclosure is applied.

The frame structure shown in FIG. 6 is purely exemplary and the number of subframes, the number of slots, and/or the number of symbols in a frame may be variously changed. In the 3GPP based wireless communication system, OFDM numerologies (e.g., subcarrier spacing (SCS), transmission time interval (TTI) duration) may be differently configured between a plurality of cells aggregated for one UE. For example, if a UE is configured with different SCSs for cells aggregated for the cell, an (absolute time) duration of a time resource (e.g., a subframe, a slot, or a TTI) including the same number of symbols may be different among the aggregated cells. Herein, symbols may include OFDM symbols (or CP-OFDM symbols), SC-FDMA symbols (or discrete Fourier transform-spread-OFDM (DFT-s-OFDM) symbols).

Referring to FIG. 6, downlink and uplink transmissions are organized into frames. Each frame has T_{f}=10 ms duration. Each frame is divided into two half-frames, where each of the half-frames has 5 ms duration. Each half-frame consists of 5 subframes, where the duration T_{sf} per subframe is 1 ms. Each subframe is divided into slots and the number of slots in a subframe depends on a subcarrier spacing. Each slot includes 14 or 12 OFDM symbols based on a cyclic prefix (CP). In a normal CP, each slot includes 14 OFDM symbols and, in an extended CP, each slot includes 12 OFDM symbols. The numerology is based on exponentially scalable subcarrier spacing βf=2^{u}*15 kHz.

Table 3 shows the number of OFDM symbols per slot N^{slot}_{symb}, the number of slots per frame N^{frame,u}ₛₗₒₜ, and the number of slots per subframe N^{subframe,u}ₛₗₒₜ for the normal CP, according to the subcarrier spacing βf=2^{u}*15 kHz.

TABLE 3

| u | N^{slot}_{symb} | N^{frame,u}ₛₗₒₜ | N^{subframe,u}ₛₗₒₜ |
|---|---|---|---|
| 0 | 14 | 10 | 1 |
| 1 | 14 | 20 | 2 |
| 2 | 14 | 40 | 4 |
| 3 | 14 | 80 | 8 |
| 4 | 14 | 160 | 16 |

Table 4 shows the number of OFDM symbols per slot N^{slot}_{symb}, the number of slots per frame N^{frame,u}ₛₗₒₜ, and the number of slots per subframe N^{subframe,u}ₛₗₒₜ for the extended CP, according to the subcarrier spacing βf=2^{u}*15 kHz.

TABLE 4

| u | N^{slot}_{symb} | N^{frame,u}ₛₗₒₜ | N^{subframe,u}ₛₗₒₜ |
|---|---|---|---|
| 2 | 12 | 40 | 4 |

A slot includes plural symbols (e.g., 14 or 12 symbols) in the time domain. For each numerology (e.g., subcarrier spacing) and carrier, a resource grid of N^{size,u}_{grid,x}*N^{RB}_{sc} subcarriers and N^{subframe,u}_{symb} OFDM symbols is defined, starting at common resource block (CRB) N^{start,u}_{grid} indicated by higher-layer signaling (e.g., RRC signaling), where N^{size,u}_{grid,x} is the number of resource blocks (RBs) in the resource grid and the subscript x is DL for downlink and UL for uplink. N^{RB}_{sc} is the number of subcarriers per RB. In the 3GPP based wireless communication system, N^{RB}_{sc} is 12 generally. There is one resource grid for a given antenna port p, subcarrier spacing configuration u, and transmission direction (DL or UL). The carrier bandwidth N^{size,u}_{grid} for subcarrier spacing configuration u is given by the higher-layer parameter (e.g., RRC parameter). Each element in the resource grid for the antenna port p and the subcarrier spacing configuration u is referred to as a resource element (RE) and one complex symbol may be mapped to each RE. Each RE in the resource grid is uniquely identified by an index k in the frequency domain and an index l representing a symbol location relative to a reference point in the time domain. In the 3GPP based wireless communication system, an RB is defined by 12 consecutive subcarriers in the frequency domain. In the 3GPP NR system, RBs are classified into CRBs and physical resource blocks (PRBs). CRBs are numbered from 0 and upwards in the frequency domain for subcarrier spacing configuration u. The center of subcarrier 0 of CRB 0 for subcarrier spacing configuration u coincides with ‘point A’ which serves as a common reference point for resource block grids. In the 3GPP NR system, PRBs are defined within a bandwidth part (BWP) and numbered from 0 to N^{size}_{BWP,i}−1, where i is the number of the bandwidth part. The relation between the physical resource block n_{PRB} in the bandwidth part i and the common resource block n_{CRB} is as follows: n_{PRB}=n_{CRB}+N^{size}_{BWP,i}, where N^{size}_{BWP,i} is the common resource block where bandwidth part starts relative to CRB 0. The BWP includes a plurality of consecutive RBs. A carrier may include a maximum of N (e.g., 5) BWPs. A UE may be configured with one or more BWPs on a given component carrier. Only one BWP among BWPs configured to the UE can active at a time. The active BWP defines the UE's operating bandwidth within the cell's operating bandwidth.

In the present disclosure, the term “cell” may refer to a geographic area to which one or more nodes provide a communication system, or refer to radio resources. A “cell” as a geographic area may be understood as coverage within which a node can provide service using a carrier and a “cell” as radio resources (e.g., time-frequency resources) is associated with bandwidth which is a frequency range configured by the carrier. The “cell” associated with the radio resources is defined by a combination of downlink resources and uplink resources, for example, a combination of a DL component carrier (CC) and a UL CC. The cell may be configured by downlink resources only, or may be configured by downlink resources and uplink resources. Since DL coverage, which is a range within which the node is capable of transmitting a valid signal, and UL coverage, which is a range within which the node is capable of receiving the valid signal from the UE, depends upon a carrier carrying the signal, the coverage of the node may be associated with coverage of the “cell” of radio resources used by the node. Accordingly, the term “cell” may be used to represent service coverage of the node sometimes, radio resources at other times, or a range that signals using the radio resources can reach with valid strength at other times.

In CA, two or more CCs are aggregated. A UE may simultaneously receive or transmit on one or multiple CCs depending on its capabilities. CA is supported for both contiguous and non-contiguous CCs. When CA is configured, the UE only has one RRC connection with the network. At RRC connection establishment/re-establishment/handover, one serving cell provides the NAS mobility information, and at RRC connection re-establishment/handover, one serving cell provides the security input. This cell is referred to as the primary cell (PCell). The PCell is a cell, operating on the primary frequency, in which the UE either performs the initial connection establishment procedure or initiates the connection re-establishment procedure. Depending on UE capabilities, secondary cells (SCells) can be configured to form together with the PCell a set of serving cells. An SCell is a cell providing additional radio resources on top of special cell (SpCell). The configured set of serving cells for a UE therefore always consists of one PCell and one or more SCells. For dual connectivity (DC) operation, the term SpCell refers to the PCell of the master cell group (MCG) or the primary SCell (PSCell) of the secondary cell group (SCG). An SpCell supports PUCCH transmission and contention-based random access, and is always activated. The MCG is a group of serving cells associated with a master node, comprised of the SpCell (PCell) and optionally one or more SCells. The SCG is the subset of serving cells associated with a secondary node, comprised of the PSCell and zero or more SCells, for a UE configured with DC. For a UE in RRC_CONNECTED not configured with CA/DC, there is only one serving cell comprised of the PCell. For a UE in RRC_CONNECTED configured with CA/DC, the term “serving cells” is used to denote the set of cells comprised of the SpCell(s) and all SCells. In DC, two MAC entities are configured in a UE: one for the MCG and one for the SCG.

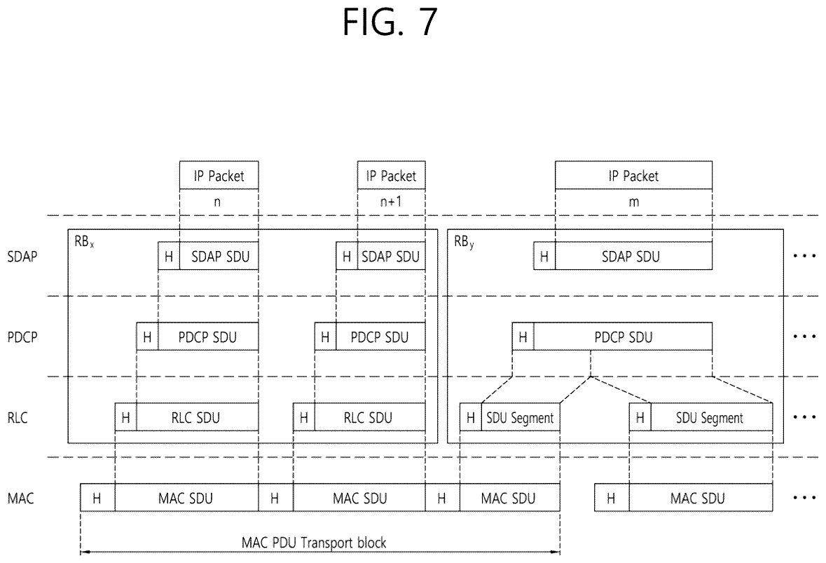

FIG. 7 shows a data flow example in the 3GPP NR system to which implementations of the present disclosure is applied.

Referring to FIG. 7, “RB” denotes a radio bearer, and “H” denotes a header. Radio bearers are categorized into two groups: DRBs for user plane data and SRBs for control plane data. The MAC PDU is transmitted/received using radio resources through the PHY layer to/from an external device. The MAC PDU arrives to the PHY layer in the form of a transport block.

In the PHY layer, the uplink transport channels UL-SCH and RACH are mapped to their physical channels physical uplink shared channel (PUSCH) and physical random access channel (PRACH), respectively, and the downlink transport channels DL-SCH, BCH and PCH are mapped to physical downlink shared channel (PDSCH), physical broadcast channel (PBCH) and PDSCH, respectively. In the PHY layer, uplink control information (UCI) is mapped to physical uplink control channel (PUCCH), and downlink control information (DCI) is mapped to physical downlink control channel (PDCCH). A MAC PDU related to UL-SCH is transmitted by a UE via a PUSCH based on an UL grant, and a MAC PDU related to DL-SCH is transmitted by a BS via a PDSCH based on a DL assignment.

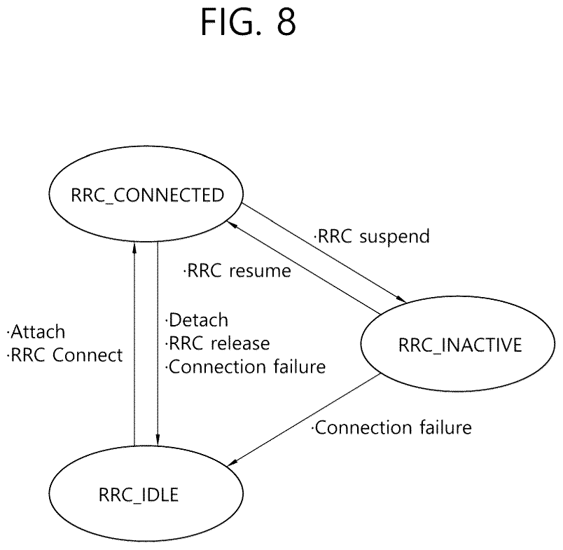

FIG. 8 shows an example of possible RRC states in a wireless communication system to which technical features of the present disclosure can be applied.

Referring to FIG. 8, there may be 3 possible RRC states in a wireless communication system (i.e., RRC_IDLE, RRC_CONNECTED and/or RRC_INACTIVE).

In RRC_IDLE (or, idle mode/state), RRC context for communication between a UE and a network may not be established in RAN, and the UE may not belong to a specific cell. Also, in RRC_IDLE, there is no core network connection for the UE. Since the device remains in sleep mode in most of the time to reduce battery consumption, data transfer between the UE and the network may not occur. UEs in RRC_IDLE may periodically wake-up to receive paging messages from the network. Mobility may be handled by the UE through cell reselection. Since uplink synchronization is not maintained, the UE may not perform uplink transmission other than transmissions for random access (e.g., random access preamble transmission) to move to RRC_CONNECTED.

In RRC_CONNECTED (or, connected state/mode), RRC context for communication between a UE and a network may be established in RAN. Also, in RRC_CONNECTED, core network connection is established for the UE. Since the UE belongs to a specific cell, cell-radio network temporary identifier (C-RNTI) for signalings between the UE and the network may be configured for the UE. Data transfer between the UE and the network may occur. Mobility may be handled by the network—that is, the UE may provide measurement report to the network, and the network may transmit mobility commands to the UE to perform a mobility. Uplink time alignment may need to be established based on a random access and maintained for data transmission.

In RRC_INACTIVE (or, inactive state/mode), RRC context for communication between a UE and a network may be kept in RAN. Data transfer between the UE and the network may not occur. Since core network connection may also be kept for the UE, the UE may fast transit to a connected state for data transfer. In the transition, core network signalling may not be needed. The RRC context may be already established in the network and idle-to-active transitions can be handled in the RAN. The UE may be allowed to sleep in a similar way as in RRC_IDLE, and mobility may be handled through cell reselection without involvement of the network. The RRC_INCATIVE may be construed as a mix of the idle state and the connected state.

As illustrated in FIG. 8, the UE may transit to RRC_CONNECTED from RRC_IDLE by performing initial attach procedure or RRC connection establishment procedure. For example, the UE may perform the RRC connection establishment procedure based on receiving a CN-initiated paging. The UE may transit to RRC_IDLE from RRC_CONNECTED when detach, RRC connection release (e.g., when the UE receives RRC release message) and/or connection failure (e.g., radio link failure (RLF)) has occurred. The UE may transit to RRC_INACTIVE from RRC_CONNECTED when RRC connection is suspended (e.g., when the UE receives RRC release message including a suspend configuration), and transit to RRC_CONNECTED from RRC_INACTIVE when RRC connection is resume by performing RRC connection resume procedure. For example, the UE may perform the RRC connection resume procedure based on receiving a RAN-initiated paging. The UE may transit to RRC_IDLE from RRC_INACTIVE when connection failure such as RLF has occurred.

A UE in RRC_IDLE or RRC_INACTIVE may receive paging information from a network in a paging procedure. The network initiates the paging procedure by transmitting the Paging message at the UE's paging occasion. The network may address multiple UEs within a Paging message by including one PagingRecord for each UE.

Upon receiving the Paging message, the UE shall:
1> if in RRC_IDLE, for each of the PagingRecord, if any, included in the Paging message:
2> if the ue-Identity included in the PagingRecord matches the UE identity allocated by upper layers:
3> forward the ue-Identity and accessType (if present) to the upper layers;
1> if in RRC_INACTIVE, for each of the PagingRecord, if any, included in the Paging message:
2> if the ue-Identity included in the PagingRecord matches the UE's stored fullI-RNTI:
3> if the UE is configured by upper layers with Access Identity 1:
4> initiate the RRC connection resumption procedure with resumeCause set to mps-PriorityAccess;
3> else if the UE is configured by upper layers with Access Identity 2:
4> initiate the RRC connection resumption procedure with resumeCause set to mcs-PriorityAccess;
3> else if the UE is configured by upper layers with one or more Access Identities equal to 11-15:
4> initiate the RRC connection resumption procedure with resumeCause set to highPriorityAccess;
3> else:
4> initiate the RRC connection resumption procedure with resumeCause set to mt-Access;
2> else if the ue-Identity included in the PagingRecord matches the UE identity allocated by upper layers:
3> forward the ue-Identity to upper layers and accessType (if present) to the upper layers;
3> perform the actions upon going to RRC_IDLE with release cause ‘other’.

The contents of the paging message is described in table 5:

TABLE 5

| | |
|---|---|
| -- ASN1START | |
| -- TAG-PAGING-START | |
| Paging ::= | SEQUENCE { |
| pagingRecordList | PagingRecordList |
| OPTIONAL, -- Need N | |
| lateNonCriticalExtension | OCTET STRING |
| OPTIONAL, | |
| nonCriticalExtension | SEQUENCE{ } |
| OPTIONAL | |
| } | |
| PagingRecordList ::= | SEQUENCE |
| (SIZE(1..maxNrofPageRec)) OF PagingRecord | |
| PagingRecord ::= | SEQUENCE { |
| ue-Identity | PagingUE-Identity, |
| accessType | ENUMERATED {non3GPP} |
| OPTIONAL, -- Need N | |
| . . . | |
| } | |
| PagingUE-Identity ::= | CHOICE { |
| ng-5G-S-TMSI | NG-5G-S-TMSI, |
| fullI-RNTI | I-RNTI-Value, |
| . . . | |
| } | |
| -- TAG-PAGING-STOP | |
| -- ASN1STOP | |

The accessType indicates whether the Paging message is originated due to the PDU sessions from the non-3GPP access. Hereinafter, contents regarding a bandwidth part (BWP) is described.

With Bandwidth Adaptation (BA), the receive and transmit bandwidth of a UE need not be as large as the bandwidth of the cell and can be adjusted: the width can be ordered to change (e.g. to shrink during period of low activity to save power); the location can move in the frequency domain (e.g. to increase scheduling flexibility); and the subcarrier spacing can be ordered to change (e.g. to allow different services). A subset of the total cell bandwidth of a cell is referred to as a Bandwidth Part (BWP) and BA is achieved by configuring the UE with BWP(s) and telling the UE which of the configured BWPs is currently the active one.

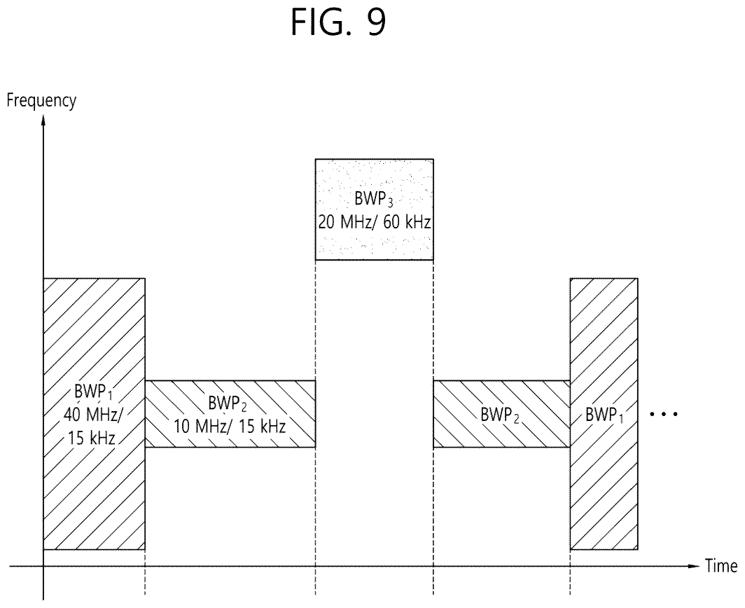

FIG. 9 shows an example of bandwidth adaptation according to an embodiment of the present disclosure. FIG. 9 describes a scenario where 3 different BWPs are configured:
BWP₁ with a width of 40 MHz and subcarrier spacing of 15 kHz;
BWP₂ with a width of 10 MHz and subcarrier spacing of 15 kHz;
BWP₃ with a width of 20 MHz and subcarrier spacing of 60 kHz.

To enable BA on the PCell, the gNB configures the UE with UL and DL BWP(s). To enable BA on SCells in case of CA, the gNB configures the UE with DL BWP(s) at least (i.e. there may be none in the UL). For the PCell, the BWP used for initial access is configured via system information. For the SCell(s), the BWP used after initial activation is configured via dedicated RRC signaling.

In paired spectrum, DL and UL can switch BWP independently. In unpaired spectrum, DL and UL switch BWP simultaneously. Switching between configured BWPs happens by means of RRC signalling, DCI, inactivity timer or upon initiation of random access. When an inactivity timer is configured for a serving cell, the expiry of the inactivity timer associated to that cell switches the active BWP to a default BWP configured by the network. There can be at most one active BWP per cell, except when the serving cell is configured with SUL, in which case there can be at most one on each UL carrier.

A bandwidth part is a subset of contiguous common resource blocks for a given numerology uᵢ in bandwidth part i on a given carrier. For example, BWP may be a contiguous set of physical resource blocks (PRBs), selected from a contiguous subset of the common resource blocks (CRBs) for a given numerology u on a given carrier.

A UE can be configured with up to four bandwidth parts in the downlink with a single downlink bandwidth part being active at a given time. The UE is not expected to receive PDSCH, PDCCH, or CSI-RS (except for RRM) outside an active bandwidth part.

A UE can be configured with up to four bandwidth parts in the uplink with a single uplink bandwidth part being active at a given time. If a UE is configured with a supplementary uplink, the UE can in addition be configured with up to four bandwidth parts in the supplementary uplink with a single supplementary uplink bandwidth part being active at a given time. The UE shall not transmit PUSCH or PUCCH outside an active bandwidth part. For an active cell, the UE shall not transmit SRS outside an active bandwidth part.

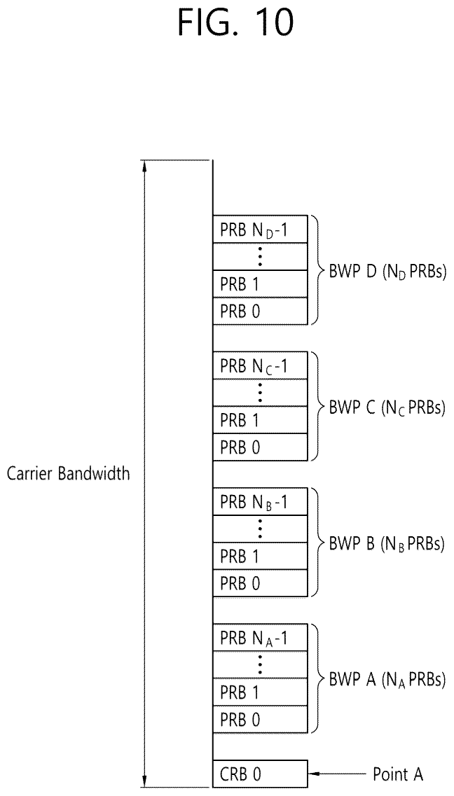

FIG. 10 shows an example of a BWP configuration to which technical features of the present disclosure is applied.

Referring to FIG. 10, 4 BWPs (i.e., BWP A, BWP B, BWP C and BWP D) are configured in a carrier bandwidth. The carrier bandwidth (or, carrier band) may comprise CRBs numbered from CRB0. CRB0 may correspond to or may be determined based on point A. Point A may indicate a common reference point for resource block grids and may be obtained from higher layer parameters.

The BWP A may comprise N_{A} PRBs numbered from PRB0 to PRB N_{A}−1. The PRB0 in the BWP A may have the number of offset PRBs/CRBs with respect to the CRB0, which may or may not be configured from a network.

The BWP B may comprise N_{B} PRBs numbered from PRB0 to PRB N_{B}−1. The PRB0 in the BWP B may have the number of offset PRBs/CRBs with respect to the CRB0, which may or may not configured from a network.

The BWP C may comprise N_{C} PRBs numbered from PRB0 to PRB N_{C}−1. The PRB0 in the BWP C may have the number of offset PRBs/CRBs with respect to the CRB0, which may or may not configured from a network.

The BWP D may comprise N_{D} PRBs numbered from PRB0 to PRB N_{D}−1. The PRB0 in the BWP D may have the number of offset PRBs/CRBs with respect to the CRB0, which may or may not configured from a network.

There may be various types of BWPs, such as initial BWP, first active BWP, default BWPs, and/or regular BWPs.

Initial BWP may be used for initial access (e.g., DL synchronization procedure, random access procedure) before RRC connection is established.

First active BWP may be a BWP to be active right after the initial attach is completed.

Default BWP may be a BWP to which UE and/or network automatically switches when there is no activity in current BWP while BWP inactivity timer is running. The BWP inactivity timer may indicate a duration after which the UE falls back to the default BWP.

In downlink, a UE can be configured with up to four carrier BWPs. The bandwidth of each BWP should be equal or greater than synchronization signal (SS) Block bandwidth (BW), but each BW may or may not contain SS Block. Only one carrier BWP can be active at a given time. The UE may not be expected to receive PDSCH, PDCCH, CSI-RS, and/or TRS outside an active bandwidth part. Each DL BWP may include at least one CORESET with UE Specific Search Space (USS). In primary carrier, at least one of the configured DL BWPs may include one CORESET with common search space (CSS).

In uplink, a UE can be configured with up to four carrier bandwidth parts. Only one carrier bandwidth part can be active at a given time. If a UE is configured with a supplementary uplink, the UE can in addition be configured with up to four carrier bandwidth parts in the supplementary uplink, and/or only one carrier bandwidth part can be active at a given time. The UE shall not transmit PUSCH or PUCCH outside an active bandwidth part.

In an initial access procedure, the initial BWP may be an active BWP. The initial BWP may be configured via RRC signalling.

Right after the initial attach is completed, the first active BWP may be an active BWP. The first active BWP may be configured via RRC signalling.

A specific BWP can be activated by BWP indicator in DCL When a UE receives the DCI including the BWP indicator while the UE is on the first active BWP or other active BWP, the active BWP may be switched to the specific BWP indicated by the BWP indicator.

If a BWP inactivity timer expires, the default BWP may be an active BWP.

The BWP switching for a Serving Cell is used to activate an inactive BWP and deactivate an active BWP at a time. The BWP switching is controlled by the PDCCH indicating a downlink assignment or an uplink grant, by the bwp-InactivityTimer, by RRC signalling, or by the MAC entity itself upon initiation of Random Access procedure or upon detection of consistent LBT failure on SpCell. Upon RRC (re-)configuration of firstActiveDownlinkBWP-Id and/or firstActiveUplinkBWP-Id for SpCell or activation of an SCell, the DL BWP and/or UL BWP indicated by firstActiveDownlinkBWP-Id and/or firstActiveUplinkBWP-Id respectively is active without receiving PDCCH indicating a downlink assignment or an uplink grant. The active BWP for a Serving Cell is indicated by either RRC or PDCCH. For unpaired spectrum, a DL BWP is paired with a UL BWP, and BWP switching is common for both UL and DL.

For each SCell a dormant BWP may be configured with dormantBWP-Id by RRC signalling. Entering or leaving dormant BWP for SCells is done by BWP switching per SCell or per dormancy SCell group based on instruction from PDCCH. The dormancy SCell group configurations are configured by RRC signalling. Upon reception of the PDCCH indicating leaving dormant BWP, the DL BWP indicated by firstOutsideActiveTimeBWP-Id or by firstWithinActiveTimeBWP-Id is activated. Upon reception of the PDCCH indicating entering dormant BWP, the DL BWP indicated by dormantBWP-Id is activated. The dormant BWP configuration for SpCell or PUCCH SCell is not supported.

For each activated Serving Cell configured with a BWP, the MAC entity shall:
1> if a BWP is activated and the active DL BWP for the Serving Cell is not the dormant BWP:
2> transmit on UL-SCH on the BWP;
2> transmit on RACH on the BWP, if PRACH occasions are configured;
2> monitor the PDCCH on the BWP;
2> transmit PUCCH on the BWP, if configured;
2> report CSI for the BWP;
2> transmit SRS on the BWP, if configured;
2> receive DL-SCH on the BWP;
2> (re-)initialize any suspended configured uplink grants of configured grant Type 1 on the active BWP according to the stored configuration, if any, and to start in the symbol;
2> if lbt-FailureRecoveryConfig is configured:
3> stop the lbt-FailureDetectionTimer, if running;
3> set LBT_COUNTER to 0;
3> monitor LBT failure indications from lower layers.
1> if a BWP is activated and the active DL BWP for the Serving Cell is dormant BWP:
2> stop the bwp-InactivityTimer of this Serving Cell, if running.
2> not monitor the PDCCH on the BWP;
2> not monitor the PDCCH for the BWP;
2> not receive DL-SCH on the BWP;
2> not report CSI on the BWP, report CSI except aperiodic CSI for the BWP;
2> not transmit SRS on the BWP;
2> not transmit on UL-SCH on the BWP;
2> not transmit on RACH on the BWP;
2> not transmit PUCCH on the BWP.
2> clear any configured downlink assignment and any configured uplink grant Type 2 associated with the SCell respectively;
2> suspend any configured uplink grant Type 1 associated with the SCell;
2> if configured, perform beam failure detection and beam failure recovery for the SCell if beam failure is detected.
1> if a BWP is deactivated:
2> not transmit on UL-SCH on the BWP;
2> not transmit on RACH on the BWP;
2> not monitor the PDCCH on the BWP;
2> not transmit PUCCH on the BWP;
2> not report CSI for the BWP;
2> not transmit SRS on the BWP;
2> not receive DL-SCH on the BWP;
2> clear any configured downlink assignment and configured uplink grant of configured grant Type 2 on the BWP;
2> suspend any configured uplink grant of configured grant Type 1 on the inactive BWP.

Upon initiation of the Random Access procedure on a Serving Cell, after the selection of carrier for performing Random Access procedure, the MAC entity shall for the selected carrier of this Serving Cell:
1> if PRACH occasions are not configured for the active UL BWP:
2> switch the active UL BWP to BWP indicated by initialUplinkBWP;
2> if the Serving Cell is an SpCell:
3> switch the active DL BWP to BWP indicated by initialDownlinkBWP.
1> else:
2> if the Serving Cell is an SpCell:
3> if the active DL BWP does not have the same bwp-Id as the active UL BWP:
4> switch the active DL BWP to the DL BWP with the same bwp-Id as the active UL
1> stop the bwp-InactivityTimer associated with the active DL BWP of this Serving Cell, if running.
1> if the Serving Cell is SCell:
2> stop the bwp-InactivityTimer associated with the active DL BWP of SpCell, if running.
1> perform the Random Access procedure on the active DL BWP of SpCell and active UL BWP of this Serving Cell.

If the MAC entity receives a PDCCH for BWP switching of a Serving Cell, the MAC entity shall:
1> if there is no ongoing Random Access procedure associated with this Serving Cell; or
1> if the ongoing Random Access procedure associated with this Serving Cell is successfully completed upon reception of this PDCCH addressed to C-RNTI:
2> cancel, if any, triggered consistent LBT failure for this Serving Cell;
2> perform BWP switching to a BWP indicated by the PDCCH.

If the MAC entity receives a PDCCH for BWP switching for a Serving Cell(s) or a dormancy SCell group(s) while a Random Access procedure associated with that Serving Cell is ongoing in the MAC entity, it is up to UE implementation whether to switch BWP or ignore the PDCCH for BWP switching, except for the PDCCH reception for BWP switching addressed to the C-RNTI for successful Random Access procedure completion in which case the UE shall perform BWP switching to a BWP indicated by the PDCCH. Upon reception of the PDCCH for BWP switching other than successful contention resolution, if the MAC entity decides to perform BWP switching, the MAC entity shall stop the ongoing Random Access procedure and initiate a Random Access procedure after performing the BWP switching; if the MAC decides to ignore the PDCCH for BWP switching, the MAC entity shall continue with the ongoing Random Access procedure on the Serving Cell.

Upon reception of RRC (re-)configuration for BWP switching for a Serving Cell while a Random Access procedure associated with that Serving Cell is ongoing in the MAC entity, the MAC entity shall stop the ongoing Random Access procedure and initiate a Random Access procedure after performing the BWP switching.

Upon reception of RRC (re-)configuration for BWP switching for a Serving Cell, cancel any triggered LBT failure in this Serving Cell.

The MAC entity shall for each activated Serving Cell configured with bwp-InactivityTimer:
1> if the defaultDownlinkBWP-Id is configured, and the active DL BWP is not the BWP indicated by the defaultDownlinkBWP-Id, and the active DL BWP is not the BWP indicated by the dormantBWP-Id if configured; or
1> if the defaultDownlinkBWP-Id is not configured, and the active DL BWP is not the initialDownlinkBWP, and the active DL BWP is not the BWP indicated by the dormantBWP-Id if configured:
2> if a PDCCH addressed to C-RNTI or CS-RNTI indicating downlink assignment or uplink grant is received on the active BWP; or
2> if a PDCCH addressed to C-RNTI or CS-RNTI indicating downlink assignment or uplink grant is received for the active BWP; or
2> if a MAC PDU is transmitted in a configured uplink grant and LBT failure indication is not received from lower layers; or
2> if a MAC PDU is received in a configured downlink assignment:
3> if there is no ongoing Random Access procedure associated with this Serving Cell; or
3> if the ongoing Random Access procedure associated with this Serving Cell is successfully completed upon reception of this PDCCH addressed to C-RNTI:
4> start or restart the bwp-InactivityTimer associated with the active DL BWP.
2> if the bwp-InactivityTimer associated with the active DL BWP expires:
3> if the defaultDownlinkBWP-Id is configured:
4> perform BWP switching to a BWP indicated by the defaultDownlinkBWP-Id.
3> else:
4> perform BWP switching to the initialDownlinkBWP.

If a Random Access procedure is initiated on an SCell, both this SCell and the SpCell are associated with this Random Access procedure.
1> if a PDCCH for BWP switching is received, and the MAC entity switches the active DL BWP:
2> if the defaultDownlinkBWP-Id is configured, and the MAC entity switches to the DL BWP which is not indicated by the defaultDownlinkBWP-Id and is not indicated by the dormantBWP-Id if configured; or
2> if the defaultDownlinkBWP Id is not configured, and the MAC entity switches to the DL BWP which is not the initialDownlinkBWP and is not indicated by the dormantBWP-Id if configured:
3> start or restart the bwp-InactivityTimer associated with the active DL BWP.

Hereinafter, multicast-broadcast service (MBS) is described.

MBS is a point-to-multipoint (PTM) communication scheme where data packets are transmitted simultaneously from a single source (e.g., base station and/or DU) to multiple destinations (e.g., UEs). The MBS may comprise at least one of a broadcast communication service (or, simply broadcast service) or a multicast communication service (or, simply multicast service).

In broadcast communication service, the same service and the same specific content data may be provided simultaneously to all UEs in a geographical area (i.e., all UEs in a broadcast coverage area may be authorized to receive the data). The broadcast communication service may be delivered to the UEs using a broadcast session. In the case of broadcast session, the UE can receive MBS data in RRC_IDLE, RRC_INACTIVE and/or RRC_CONNECTED state.

In multicast communication service, the same service and the same specific content data may be provided simultaneously to a dedicated set of UEs (i.e., not all UEs in a multicast coverage area may be authorized to receive the data). The multicast communication service may be delivered to the UEs using a multicast session. In the case of multicast session, the UE can receive MBS data in RRC_CONNECTED, and use additional assistance mechanisms such as feedback/retransmission and/or PTP delivery.

The geographical area may be referred to as MBS area. The MBS area may comprise at least one of the broadcast coverage area or the multicast coverage area. The MBS area may comprise one or more base stations (or, one or more DUs) transmitting the same content. Each base station capable of MBS service may belong to one or more MBS areas. A UE can receive the MBS content within the MBS area in a connected state (e.g., RRC connected mode) or idle state (e.g., RRC idle mode). A base station may provide MBS service corresponding to different MBS areas.

In MBS scheme, there may be a multicast/broadcast single-frequency network (MBSFN) transmission in which identical signals may be transmitted from multiple cells with identical coding and modulation and with timing and frequency synchronized across the multiple cells. Physical multicast channel (PMCH) may be used for the MBSFN transmission. The PMCH may also contain MBS traffic and/or control information.

Compared to the MBS, a unicast service may be defined. Unicast service is a point-to-point (PTP) communication scheme data packets are transmitted from a single source to a single destination.

MBS service may be provided via MBS bearer and/or MBS radio bearer (MRB). The MBS bearer and/or MRB may be a bearer/radio bearer used for PTM service. Further, the MBS service may also be provided via a unicast bearer. The unicast bearer may be a data radio bearer (DRB) used for PTP service. Compared to DRB, the layer 2 protocols (e.g., SDAP, PDCP, RLC, MAC) for the MBS bearer and/or MRB may be different from those for the DRB. One or more quality of service (QoS) flows may be mapped to one DRB according to a QoS flow to DRB mapping rule.

With regard to MBS, the following terms may be used:
MBS identifier (ID): ID of MBS service subscribed by one or more UEs. The MBS ID may comprise at least one of a temporary mobile group identifier (TMGI), a multicast address or a broadcast address.
MRB ID and/or MBS bearer ID: ID of a bearer/radio bearer that is used for MBS service.
MRB QoS and/or MBS bearer QoS: QoS parameters that corresponds to MBS service. QoS required for the MBS service.
MBS area ID: ID of an MBS area in which MBS service is provided.

Hereinafter, group paging (or, paging for multicast activation notification) is described.

A UE can receive data of MBS multicast session only in RRC_CONNECTED state. If the UE which joined a multicast session is in RRC_CONNECTED state and when the multicast session starts, the gNB sends RRC Reconfiguration message with relevant MBS configuration for the multicast session to the UE and there is no need for separate session activation notification for this UE.

When there is (temporarily) no data to be sent to the UEs for a multicast session, the gNB may move the UE to RRC IDLE/INACTIVE state. gNBs supporting MBS use a group notification mechanism to notify the UEs in RRC IDLE/INACTIVE state when a multicast session has been activated by the CN or the gNB has multicast session data to deliver. Upon reception of the group notification, the UEs reconnect to the network. The group notification is addressed with P-RNTI on PDCCH, and the paging channels are monitored by the UE. Paging message for group notification contains MBS session ID which is utilized to page all UEs in RRC IDLE and RRC INACTIVE states that joined the associated MBS multicast session, i.e. UEs are not paged individually. The UE stops monitoring for group notifications related to a specific multicast session once the UE leaves this multicast session.

If the UE in RRC IDLE state that joined an MBS multicast session is camping on gNB not supporting MBS, the UE may be notified about multicast session activation or data availability by CN-initiated paging where CN pages each UE individually. If the UE in RRC INACTIVE state that joined MBS multicast session is camping on gNB not supporting MBS, the UE may be notified about data availability by RAN-initiated paging.

Meanwhile, the transmission of a multicast session can be temporally suspended. When the multicast transmission is suspended, the network may let UE that is receiving the multicast session in RRC_CONNECTED enter RRC_IDLE or RRC_INACTIVE to save the UE power. However, UEs which are receiving the multicast session in RRC_IDLE/INACTIVE may keep monitoring the multicast transmission even while the transmission of a multicast session is temporally suspended, and this may lead to significant waste of UE power in RRC_IDLE/INACTIVE.

According to an embodiment of the present disclosure, for a UE which supports the reception of the multicast session in RRC_IDLE or RRC_INACTIVE (e.g., UE supports multicast reception in non-connected):
if a paging message which includes a multicast session identity (ID), e.g., TMGI, but doesn't include ID of the UE is received in RRC_IDLE or RRC_INACTIVE, the UE may resume the monitoring of the multicast session using a g-RNTI associated with the multicast session without state transition to RRC_CONNECTED; and
if a paging message which includes the multicast session ID and the ID of the UE is received in RRC_IDLE or RRC_INACTIVE, the UE may initiate RRC connection establishment procedure (when UE is in RRC_IDLE) or RRC connection resume procedure (when UE is in RRC_INACTIVE) to enter RRC_CONNECTED, and receive the multicast session in RRC_CONNECTED.

According to an embodiment of the present disclosure, for a UE which doesn't support the reception of the multicast session in RRC_IDLE or RRC_INACTIVE (e.g., UE does not support multicast reception in non-connected), if a paging message including a multicast session ID is received in RRC_IDLE or RRC_INACTIVE, the UE may initiate RRC connection establishment or RRC connection resume procedure to receive the multicast session in RRC_CONNECTED.

The following drawings are created to explain specific embodiments of the present disclosure. The names of the specific devices or the names of the specific signals/messages/fields shown in the drawings are provided by way of example, and thus the technical features of the present disclosure are not limited to the specific names used in the following drawings.

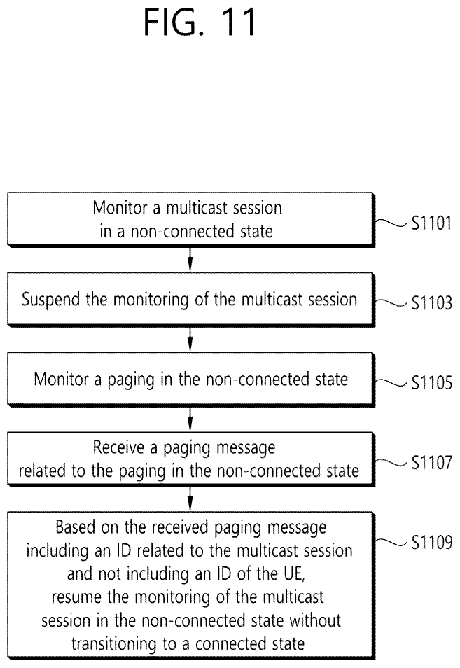

FIG. 11 shows an example of a method performed by a UE according to an embodiment of the present disclosure. The method may also be performed by a wireless device.

Referring to FIG. 11, in step S1101, the UE may monitor a multicast session in a non-connected state. The UE may monitor a temporary ID related to the multicast session (e.g., g-RNTI) and/or PDCCH with CRC scrambled by the temporary ID.

In step S1103, the UE may suspend the monitoring of the multicast session. The UE may suspend the monitoring of the multicast session based on a network indication, or autonomously suspend the monitoring of the multicast session based on some conditions.

In step S1105, the UE may monitor a paging (e.g., paging radio network temporary identifier (P-RNTI) and/or PDCCH with CRC scrambled by P-RNTI) in the non-connected state.

In step S1107, the UE may receive a paging message related to the paging in the non-connected state. The UE may receive the paging message in PDSCH scheduled by the PDCCH with CRC scrambled by P-RNTI.

In step S1109, based on the received paging message including an ID related to the multicast session and not including an ID of the UE, the UE may resume the monitoring of the multicast session in the non-connected state without transitioning to a connected state. Alternatively, based on the received paging message including the ID related to the multicast session and the ID of the UE, the UE may transition to the connected state by performing an RRC connection establishment/resume procedure, and resume the monitoring of the multicast session in the connected state.

According to various embodiments, the UE may monitor a physical downlink control channel (PDCCH) with cyclic redundancy check (CRC) scrambled by a temporary identifier related to the multicast session (e.g., g-RNTI). The UE may receive multicast data related to the multicast session on resources scheduled by the PDCCH.

According to various embodiments, the ID related to the multicast session may comprise a temporary mobile group identity (TMGI).

According to various embodiments, the UE may have joined the multicast session.

According to various embodiments, the UE may monitor the multicast session on a first frequency resource related to the multicast session in the non-connected state. The UE may switch from the first frequency resource to a second frequency resource and suspend the monitoring of the multicast session on the second frequency resource. The UE may switch from the second frequency resource to the first frequency resource and resume the monitoring of the multicast session on the first frequency resource.

According to various embodiments, the first frequency resource may be included in a plurality of frequency resources for multicast. The plurality of frequency resources may be related to different multicast sessions.

According to various embodiments, the first frequency resource may comprise at least one of a bandwidth part (BWP) for multicast or a common frequency resource (CFR) for multicast.

According to various embodiments, the second frequency resource may comprise at least one of an initial bandwidth part (BWP), a dormant BWP or a deactivated BWP.

According to various embodiments, the multicast session comprises at least one of: a first multicast session available in the non-connected state; or a second multicast session available in the connected state and unavailable in the non-connected state. Based on the received paging message including an ID related to the first multicast session, the UE may resume the monitoring of the multicast session related to the first multicast session in the non-connected state without transitioning to the connected state. Based on the received paging message including an ID related to the second multicast session, the UE may resume the monitoring of the multicast session related to the second multicast session after transitioning to the connected state.

According to various embodiments, the UE may suspend the monitoring of the multicast session based on receiving a suspend notification for the multicast session from a network.

According to various embodiments, the suspend notification for the multicast session may be received via a paging message. The UE may resume the monitoring of the multicast session based on receiving a paging message including a resume notification for the multicast session from a network. The suspend notification for the multicast session may comprise at least one of a suspend notification or the ID related to the multicast session. The resume notification for the multicast session may comprise at least one of a resume notification or the ID related to the multicast session.

According to various embodiments, the non-connected state may comprise at least one of an idle state or an inactive state.

According to various embodiments, the UE may receive a paging message including a multicast session ID. The UE may switch DL BWP to the multicast BWP corresponding to the multicast session. The UE may receive the multicast session on the multicast BWP, without state transition to RRC_CONNECTED.

Furthermore, the method in perspective of the UE described above in FIG. 11 may be performed by the first wireless device 100 shown in FIG. 2 and/or the UE 100 shown in FIG. 3.

More specifically, the UE comprises at least one transceiver, at least processor, and at least one computer memory operably connectable to the at least one processor and storing instructions that, based on being executed by the at least one processor, perform operations.

The operations comprise: monitoring a multicast session in a non-connected state; suspending the monitoring of the multicast session; monitoring a paging in the non-connected state; receiving a paging message related to the paging in the non-connected state; and based on the received paging message including an identity (ID) related to the multicast session and not including an ID of the UE, resuming the monitoring of the multicast session in the non-connected state without transitioning to a connected state.

Furthermore, the method in perspective of the UE described above in FIG. 11 may be performed by a software code 105 stored in the memory 104 included in the first wireless device 100 shown in FIG. 2.

More specifically, at least one computer readable medium (CRM) stores instructions that, based on being executed by at least one processor, perform operations comprising: monitoring a multicast session in a non-connected state; suspending the monitoring of the multicast session; monitoring a paging in the non-connected state; receiving a paging message related to the paging in the non-connected state; and based on the received paging message including an identity (ID) related to the multicast session and not including an ID of the UE, resuming the monitoring of the multicast session in the non-connected state without transitioning to a connected state.

Furthermore, the method in perspective of the UE described above in FIG. 11 may be performed by control of the processor 102 included in the first wireless device 100 shown in FIG. 2 and/or by control of the processor 102 included in the UE 100 shown in FIG. 3.

More specifically, an apparatus configured to/adapted to operate in a wireless communication system (e.g., wireless device/UE) comprises at least processor, and at least one computer memory operably connectable to the at least one processor. The at least one processor is configured to/adapted to perform operations comprising: monitoring a multicast session in a non-connected state; suspending the monitoring of the multicast session; monitoring a paging in the non-connected state; receiving a paging message related to the paging in the non-connected state; and based on the received paging message including an identity (ID) related to the multicast session and not including an ID of the UE, resuming the monitoring of the multicast session in the non-connected state without transitioning to a connected state.

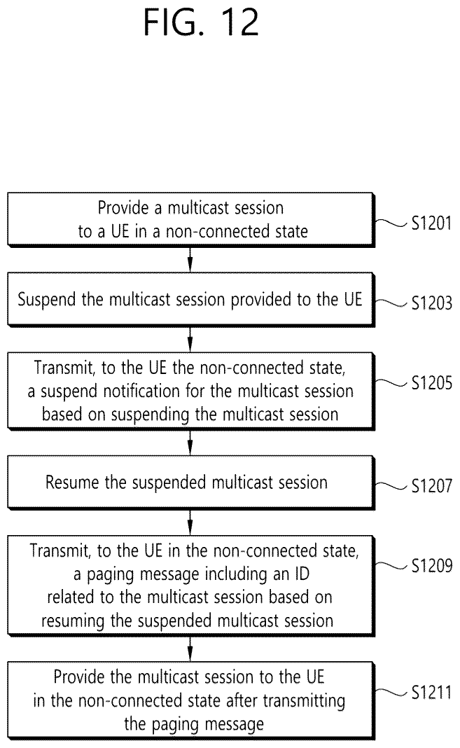

FIG. 12 shows an example of a method performed by a network node according to an embodiment of the present disclosure. The network node may comprise a base station (BS).

Referring to FIG. 12, in step S1201, the network node may provide a multicast session to a UE in a non-connected state.

In step S1203, the network node may suspend the multicast session provided to the UE.

In step S1205, the network node may transmit, to the UE the non-connected state, a suspend notification for the multicast session based on suspending the multicast session. The UE may suspend monitoring of the multicast session based on receiving the suspend notification for the multicast session from the network node.

In step S1207, the network node may resume the suspended multicast session.

In step S1209, the network node may transmit, to the UE in the non-connected state, a paging message including an ID related to the multicast session based on resuming the suspended multicast session. The UE may resume the monitoring of the multicast session in the non-connected state without transitioning to a connected state based on the paging message including the ID related to the multicast session and not including the ID of the UE.

In step S1211, the network node may provide the multicast session to the UE in the non-connected state after transmitting the paging message.

Furthermore, the method in perspective of the network node described above in FIG. 12 may be performed by the second wireless device 200 shown in FIG. 2.

More specifically, the network node comprises at least one transceiver, at least processor, and at least one computer memory operably connectable to the at least one processor and storing instructions that, based on being executed by the at least one processor, perform operations.

The operations comprise: providing a multicast session to a user equipment (UE) in a non-connected state; suspending the multicast session provided to the UE; transmitting, to the UE the non-connected state, a suspend notification for the multicast session based on suspending the multicast session; resuming the suspended multicast session; transmitting, to the UE in the non-connected state, a paging message including an identity (ID) related to the multicast session and not including an ID of the UE based on resuming the suspended multicast session; and providing the multicast session to the UE in the non-connected state after transmitting the paging message. The UE suspends monitoring of the multicast session based on receiving the suspend notification for the multicast session from the network node. The UE resumes the monitoring of the multicast session in the non-connected state without transitioning to a connected state based on the paging message including the ID related to the multicast session and not including an ID of the UE.

Hereinafter, details of the present disclosure is described.

### I. Resume Based on UE's Interest

If the received paging message includes an identity of a multicast session that the UE wants to receive, e.g. the UE has joined, but doesn't include an identity of the UE, the UE may resume the monitoring of the multicast session without state transition to RRC_CONNECTED, i.e., UE doesn't initiate the RRC connection establishment/resume procedure and/or RRC layer doesn't inform NAS layer of the paging related information, e.g., UE identity or multicast session identity.

Upon receiving the Paging message, the UE shall:
1> for each TMGI included in pagingGroupList, if any, included in the Paging message:
2> if the UE has joined an MBS session indicated by the TMGI included in the pagingGroupList:
3> if the UE supports multicast reception in RRC_IDLE and/or RRC_INACTIVE:
4> resume receiving the MBS session indicated by the TMGI included in the pagingGroupList;
3> else:
4> forward the TMGI to the upper layers.

### 2. Switching to Multicast BWP/CFR

The multicast session may be provided on a multicast BWP or common frequency resource (CFR) which is not identical to the initial BWP. Different multicast sessions may be provided on different multicast BWP/CFRs.

Upon receiving a deactivation/pause/suspend notification for a multicast session, the UE may switch from the multicast BWP/CFR to the initial BWP. The UE doesn't switch the DL BWP to the multicast BWP/CFR while the multicast session is deactivated/paused/suspended. The deactivation/pause/suspend notification may be provided on the multicast BWP/CFR.

Upon receiving a paging message including a multicast session ID that the UE wants to receive (e.g., the UE has joined), the UE may switch the DL BWP from the initial BWP to the multicast BWP/CFR corresponding to the multicast session indicated in the received paging.

Upon receiving the Paging message, the UE shall:
1> for each TMGI included in pagingGroupList, if any, included in the Paging message:
2> if the UE has joined an MBS session indicated by the TMGI included in the pagingGroupList:
3> if the UE supports multicast reception in RRC_INACTIVE:
4> switch the downlink BWP to the multicast BWP/CFR corresponding to the MBS session;
3> else:
4> forward the TMGI to the upper layers.

### 3. Resume Based on the Multicast Type

There may be two types of multicast sessions. Type #1 multicast session can be received in RRC_IDLE or RRC_INACTIVE, if UE supports multicast reception in non-connected. Type #2 multicast session cannot be received in RRC_IDLE or RRC_INACTIVE, i.e., it can be received in RRC_CONNECTED only.

Upon receiving a paging message including a multicast session ID in RRC_IDLE/INACTIVE, if the multicast session is type #1, the UE resume monitoring the multicast session without state transition to RRC_CONNECTED.

Upon receiving a paging message including a multicast session ID in RRC_IDLE/INACTIVE, if the multicast session is type #2, the UE may initiate RRC connection establishment/resume procedure to enter RRC_CONNECTED, and resume monitoring the multicast session in RRC_CONNECTED.

Upon receiving the Paging message, the UE shall:
1> for each TMGI included in pagingGroupList, if any, included in the Paging message:
2> if the UE has joined an MBS session indicated by the TMGI included in the pagingGroupList:
3> if the UE supports multicast reception in RRC_INACTIVE, and if the MBS session is allowed to be received in RRC_INACTIVE:
4> resume receiving the multicast session corresponding to the TMGI,
3> else:
4> forward the TMGIto the upper layers.

### 4. Deactivation/Pause/Suspend Notification in Paging

The activation/de-activation status may be indicated in the paging message along with the multicast session ID. If the received paging indicates the ‘activation’ for a multicast session, UE may consider the transmission of the multicast session is resumed. If the received paging indicates the ‘de-activation’ for a multicast session, UE may consider the transmission of the multicast session is suspended, and switch the DL BWP to the initial BWP. While the multicast session is suspended, the UE doesn't switch the DL BWP to the multicast BWP/CFR.

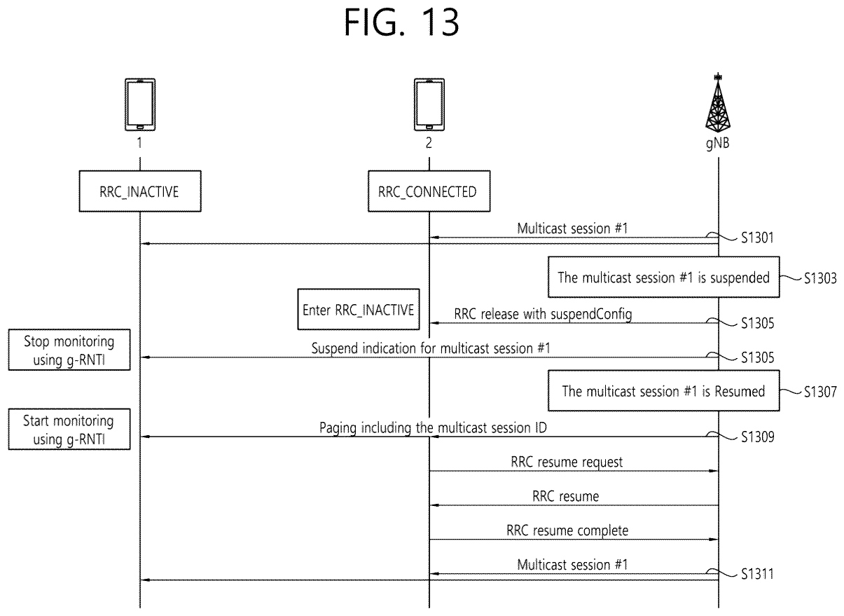

FIG. 13 shows an example of a signal flow for suspending/resuming monitoring of multicast session according to an embodiment of the present disclosure.

Referring to FIG. 13, in step S1301, UE #1 and UE #2 may receive the multicast session #1 in RRC_INACTIVE and in RRC_CONNECTED, respectively. UE #1 is capable of receiving the multicast session #1 in RRC_INACTIVE while UE #2 is not capable of receiving the multicast session #1 in RRC_INACTIVE. UE #1 and UE #2 may use the same g-RNTI that corresponds to the multicast session #1 to monitor PDCCH to receive the multicast session #1.

In step S1303, the multicast session #1 is suspended, i.e., here is no on-going data temporally for multicast session #1.

In step S1305, network may transmit RRC release message to UE #2. Upon receiving the RRC release message, UE #2 may enter RRC_INACTIVE. Network may transmit the suspend indication for multicast session #1 to UE1. Upon receiving the suspend indication, UE1 may stop/suspend monitoring the multicast session. For example, network may transmit the paging message including the multicast session ID, i.e. multicast session #1, with a suspend indicator. Upon receiving the paging message, UE #1 may switch the DL BWP from the multicast BWP to the initial BWP and stop monitoring using the g-RNTI.

In step S1307, the multicast session #1 is resumed.

In step S1309, network may transmit a paging message including the multicast session ID, i.e. multicast session #1, with a resume indicator. Upon receiving the paging message, UE #2 may initiate the RRC connection resume procedure to receive the multicast session #1 in RRC_CONNECTED. In the RRC connection resume procedure, the UE #2 may transmit a RRC resume request message to the network, receive a RRC resume message from the network, and/or transmit RRC resume complete message to the network. Upon receiving the paging message, UE #1 may switch to the multicast BWP and start monitoring the multicast session using the g-RNTI.

In step S1311, UE #1 and UE #2 may receive the multicast session #1 in RRC_INACTIVE and in RRC_CONNECTED, respectively.

The present disclosure may have various advantageous effects.

For example, UE can save the power by stopping monitoring the multicast transmission when the transmission of the multicast session is paused and by resuming the monitoring when the multicast session is resumed.

Advantageous effects which can be obtained through specific embodiments of the present disclosure are not limited to the advantageous effects listed above. For example, there may be a variety of technical effects that a person having ordinary skill in the related art can understand and/or derive from the present disclosure. Accordingly, the specific effects of the present disclosure are not limited to those explicitly described herein, but may include various effects that may be understood or derived from the technical features of the present disclosure.

Claims in the present disclosure can be combined in a various way. For instance, technical features in method claims of the present disclosure can be combined to be implemented or performed in an apparatus, and technical features in apparatus claims can be combined to be implemented or performed in a method. Further, technical features in method claim(s) and apparatus claim(s) can be combined to be implemented or performed in an apparatus. Further, technical features in method claim(s) and apparatus claim(s) can be combined to be implemented or performed in a method. Other implementations are within the scope of the following claims.

1. A method performed by a user equipment (UE) configured to operate in a wireless communication system, the method comprising:
monitoring a multicast session in a non-connected state;
suspending the monitoring of the multicast session;
monitoring a paging in the non-connected state;
receiving a paging message related to the paging in the non-connected state; and
based on the received paging message including an identity (ID) related to the multicast session and not including an ID of the UE, resuming the monitoring of the multicast session in the non-connected state without transitioning to a connected state.

2. The method of claim 1, wherein the monitoring of the multicast session comprises monitoring a physical downlink control channel (PDCCH) with cyclic redundancy check (CRC) scrambled by a temporary identifier related to the multicast session, and
wherein the method further comprises receiving multicast data related to the multicast session on resources scheduled by the PDCCH.

3. The method of claim 1, wherein the ID related to the multicast session comprises a temporary mobile group identity (TMGI).

4. The method of claim 1, wherein the UE has joined the multicast session.

5. The method of claim 1, wherein the monitoring of the multicast session comprises monitoring the multicast session on a first frequency resource related to the multicast session in the non-connected state,
wherein the resuming the monitoring of the multicast session comprises switching from a second frequency resource to the first frequency resource.

6. The method of claim 5, wherein the first frequency resource is included in a plurality of frequency resources for multicast, and
wherein the plurality of frequency resources are related to different multicast sessions.

7. The method of claim 5, wherein the suspending the monitoring of the multicast session comprises switching from the first frequency resource to the second frequency resource.

8. The method of claim 5, wherein the first frequency resource comprises at least one of a bandwidth part (BWP) for multicast or a common frequency resource (CFR) for multicast, and
wherein the second frequency resource comprises at least one of an initial bandwidth part (BWP), a dormant BWP or a deactivated BWP.

9. The method of claim 1, wherein the multicast session comprises at least one of:
a first multicast session available in the non-connected state; or
a second multicast session available in the connected state and unavailable in the non-connected state, and
wherein the method further comprises:
based on the received paging message including an ID related to the first multicast session, resuming the monitoring of the multicast session related to the first multicast session in the non-connected state without transitioning to the connected state; and
based on the received paging message including an ID related to the second multicast session, resuming the monitoring of the multicast session related to the second multicast session after transitioning to the connected state.

10. The method of claim 1, wherein the suspending the monitoring of the multicast session comprises suspending the monitoring of the multicast session based on receiving a suspend notification for the multicast session from a network.

11. The method of claim 10, wherein the suspend notification for the multicast session is received via a paging message,
wherein the resuming the monitoring of the multicast session comprises resuming the monitoring of the multicast session based on receiving a paging message including a resume notification for the multicast session from a network,
wherein the suspend notification for the multicast session comprises at least one of a suspend notification or the ID related to the multicast session, and
wherein the resume notification for the multicast session comprises at least one of a resume notification or the ID related to the multicast session.

12. The method of claim 1, wherein the non-connected state comprises at least one of an idle state or an inactive state.

13. The method of claim 1, wherein the UE is in communication with at least one of a mobile device, a network, or autonomous vehicles.

14. (canceled)

15. A user equipment (UE) configured to operate in a wireless communication system, the UE comprising:
at least one transceiver;
at least one processor; and
at least one memory operatively coupled to the at least one processor and storing instructions that, based on being executed by the at least one processor, perform operations comprising:
monitoring a multicast session in a non-connected state;
suspending the monitoring of the multicast session;
monitoring a paging in the non-connected state;
receiving a paging message related to the paging in the non-connected state; and
based on the received paging message including an identity (ID) related to the multicast session and not including an ID of the UE, resuming the monitoring of the multicast session in the non-connected state without transitioning to a connected state.

16. A network node configured to operate in a wireless communication system, the network node comprising:
at least one transceiver;
at least one processor; and
at least one memory operatively coupled to the at least one processor and storing instructions that, based on being executed by the at least one processor, perform operations comprising:
providing a multicast session to a user equipment (UE) in a non-connected state;
suspending the multicast session provided to the UE;
transmitting, to the UE the non-connected state, a suspend notification for the multicast session based on suspending the multicast session;
resuming the suspended multicast session;
transmitting, to the UE in the non-connected state, a paging message including an identity (ID) related to the multicast session and not including an ID of the UE based on resuming the suspended multicast session; and
providing the multicast session to the UE in the non-connected state after transmitting the paging message,
wherein the UE suspends monitoring of the multicast session based on receiving the suspend notification for the multicast session from the network node, and
wherein the UE resumes the monitoring of the multicast session in the non-connected state without transitioning to a connected state based on the paging message including the ID related to the multicast session and not including an ID of the UE.

17-20. (canceled)
